(19) United States
(12) Patent Application Publication
(10) Pub. No.: US 2025/0077242 A1
(43) Pub. Date: Mar. 6, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TETSUHIDE TAKASAKI, Tokyo (JP)

(21) Appl. No.: 18/808,152

(22) Filed: Aug. 19, 2024

(30) Foreign Application Priority Data
Aug. 30, 2023 (JP) 2023-140008
Aug. 30, 2023 (JP) 2023-140025

(51) Int. Cl. G06F 9/445

(52) U.S. Cl. CPC G06F 9/44526

(57) ABSTRACT

An information processing apparatus includes a second application called via a plug-in module built into one or more first applications as host applications, and configured to obtain data created by the first application via the plug-in module, process the obtained data as data to be processed, and return the processed data to the first application via one of the plug-in modules, wherein the second application includes an obtaining unit that obtains attribute information of the data to be processed as the data to be processed is obtained, and obtains function information of the first application that created the data to be processed, and a determination unit that determines the first application to return the processed data based on the attribute information and the function information obtained by the obtaining unit, and determines the plug-in module hosted by the determined first application as an output destination of the processed data.

### BACKGROUND OF THE INVENTION

### Field of the Invention

The present disclosure relates to data processing and data output using a plug-in module.

### Description of the Related Art

There is a known method of extending the functionality of an application program (hereinafter referred to as an app) by incorporating an additional program called a plug-in module into the app. In this method, a host app requests processing to be executed by a different app having a different functionality via the plug-in module. In response to the request, the different app executes the processing, and the processed data is returned to the host again via the plug-in module.

However, in an environment where a plurality of host apps each have a plug-in module built therein, if a different app executes processing in response to a processing request from each host app and returns the processed data to the host app, the processing contents may not be reflected correctly. For example, in a case where data created by a plurality of host apps having different functionalities is combined and processed by a different app, information that cannot be handled by the functionality of the host app to which the data is returned is added, and the processing results from the different app cannot be reflected correctly in the host app.

As for transferring of information between programs, Japanese Patent Laid-Open No. 2013-030141 (Patent Document 1) discloses a method for preventing the loss of information required by a second processing program in a case of sending a document processed by a first processing program to the second processing program. In the method of Patent Document 1, the first processing program displays a user interface that prevents the user from selecting a predetermined function, so that the information required by the second processing program does not get lost.

However, the method of Patent Document 1 does not take into consideration a case where an inconsistency occurs between the source and destination of data. As in the above example, if data created by a plurality of host apps having different functionalities is combined and processed in another app, the processing results cannot be correctly reflected even if they are sent to the host app.

It is an object of the present disclosure to enable correct output of processed data in a case where data created by a plurality of host apps is called from a plug-in module of each host app and processed by another app, and the processed data is returned to one of the calling host apps.

### SUMMARY OF THE INVENTION

An information processing apparatus of the present disclosure includes a second application called via a plug-in module built into one or more first applications as host applications, and configured to obtain data created by the first application via the plug-in module, process the obtained data as data to be processed, and return the processed data to the first application via one of the plug-in modules, wherein the second application includes an obtaining unit that obtains attribute information of the data to be processed as the data to be processed is obtained, and obtains function information of the first application that created the data to be processed, and a determination unit that determines the first application to return the processed data based on the attribute information and the function information obtained by the obtaining unit, and determines the plug-in module hosted by the determined first application as an output destination of the processed data.

Further features of the present invention will become apparent from the following description of exemplary embodiments with reference to the attached drawings.

### BRIEF DESCRIPTION OF THE DRAWINGS

FIG. 1 is a block diagram showing a hardware configuration of a print system;

FIG. 2 is a block diagram showing a hardware configuration of a printing apparatus;

FIG. 3 is a diagram showing an example of a software configuration of the print system;

FIGS. 4A and 4B are diagrams showing an example of a design app screen;

FIG. 5 is a diagram showing an example of a processing sequence of a plug-in module;

FIG. 6 is a flowchart showing a flow of label data addition processing;

FIGS. 7A to 7C are diagrams showing an example of label data;

FIGS. 8A to 8C are diagrams showing an example of attribute information of the label data;

FIGS. 9A to 9C are diagrams showing an example of function information of a host app;

FIGS. 10A to 10D are diagrams showing an example of a list of output destination candidates;

FIG. 11 is a flowchart showing a flow of output destination determination processing;

FIG. 12 is a diagram showing an example of a layout app screen;

FIG. 13 is a diagram showing an example of a layout app screen;

FIG. 14 is a diagram showing an example of a layout app screen;

FIG. 15 is a diagram showing an example of a layout app screen;

FIG. 16 is a flowchart showing a flow of output destination determination processing according to a second embodiment;

FIG. 17 is a diagram showing an example of a selection screen;

FIGS. 18A to 18D are diagrams showing information obtained by a layout app;

FIG. 19 is a flowchart showing a flow of output destination determination processing according to a third embodiment;

FIG. 20 is a diagram showing an example of a layout app screen;

FIG. 21 is a flowchart showing a flow of label data addition processing according to a fourth embodiment;

FIGS. 22A to 22G are diagrams showing an example of a list of output destination candidates according to the fourth embodiment;

FIG. 23 is a flowchart showing a flow of output destination determination processing according to the fourth embodiment;

FIG. 24 is a diagram showing an example of a layout app screen;

FIG. 25 is a diagram showing an example of an editing data warning screen;

FIG. 26 is a diagram showing an example of a layout app screen;

FIG. 27 is a diagram showing an example of a layout app screen;

FIG. 28 is a diagram showing an example of a layout app screen;

FIG. 29 is a diagram showing an example of a layout app screen;

FIG. 30 is a flowchart showing a flow of edited data save processing according to a fifth embodiment;

FIG. 31 is a diagram showing an example of edited data;

FIGS. 32A to 32C are diagrams showing an example of attribute information obtained by a layout app; and

FIG. 33 is a diagram showing an example of edited data after reprocessing.

### DESCRIPTION OF THE EMBODIMENTS

Preferred embodiments of the present disclosure will be described in detail below with reference to the accompanying drawings. Note that the following embodiments are not intended to limit the present disclosure according to the claims, and all of the combinations of features described in the embodiments are not necessarily essential to the solution of the present disclosure.

### First Embodiment

### Hardware Configuration of Print System

In the present embodiment, a print system used in a label printing process will be described as an example. Note that the present disclosure is not limited to this example and can be applied to various information processing systems. Furthermore, data to be processed is not limited to label data, and document data, image data, and other data are applicable.

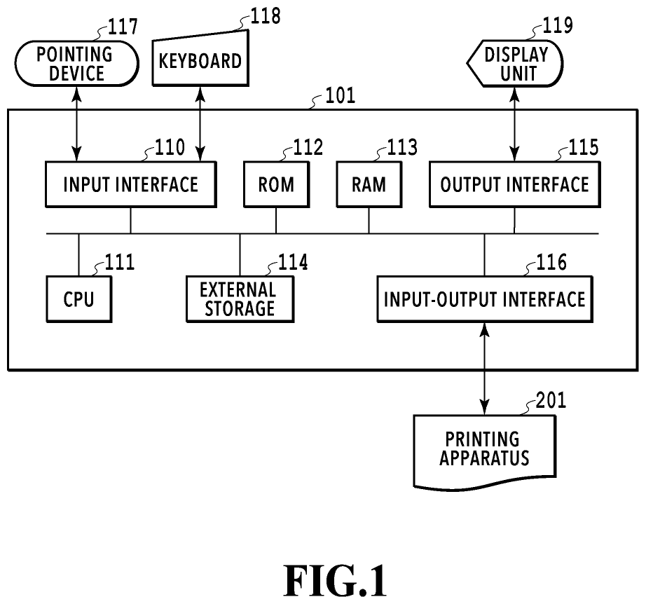

FIG. 1 is a block diagram showing a hardware configuration of a print system.

As shown in FIG. 1, the print system is configured including a host computer 101 and a printing apparatus 201. The host computer 101 is an embodiment of an information processing apparatus of the present disclosure.

The host computer 101 includes an input interface 110, a CPU 111, a ROM 112, a RAM 113, an external storage 114, an output interface 115, and an input-output interface 116. Input devices such as a keyboard 118 and a pointing device 117 are connected to the input interface 110, and display devices such as a display unit 119 are connected to the output interface 115.

The CPU 111 is a control unit that controls the host computer 101. The CPU 111 calls programs stored in the ROM 112, the external storage 114 or the like into a work area of the RAM 113 and executes the programs. The ROM 112 stores an initialization program. The external storage 114 stores programs related to applications to be described later, an operating system (OS), and various other data. The RAM 113 is used as a work memory for the CPU 111 to execute the programs.

The programs to be executed by the host computer 101 include a design application (hereinafter referred to as the design app) 400 and a layout application (hereinafter referred to as the layout app) 600. These applications will be described later. In the print system of the present embodiment, the CPU 111 reads a program stored in the ROM 112 or the external storage 114, and executes processing described in the program according to the procedure of a flowchart to be described later. The host computer 101 thus realizes various functions to be described later.

The printing apparatus 201 is connected to the host computer 101 through the input-output interface 116. Note that a plurality of printing apparatuses 201 may be connected to the host computer 101. Here, an example is described where the host computer 101 and the printing apparatus 201 are configured separately, but the host computer 101 and the printing apparatus 201 may be configured as a single apparatus. Similarly, a plurality of host computers 101 may be connected to the printing apparatus 201.

In the present embodiment, description is given of an example where the printing apparatus 201 is an ink jet printer for printing by ejecting ink onto a printing medium such as paper, but printing may be performed by other methods (for example, electrophotography). The host computer 101 may be a desktop personal computer, a smartphone, or a notebook computer.

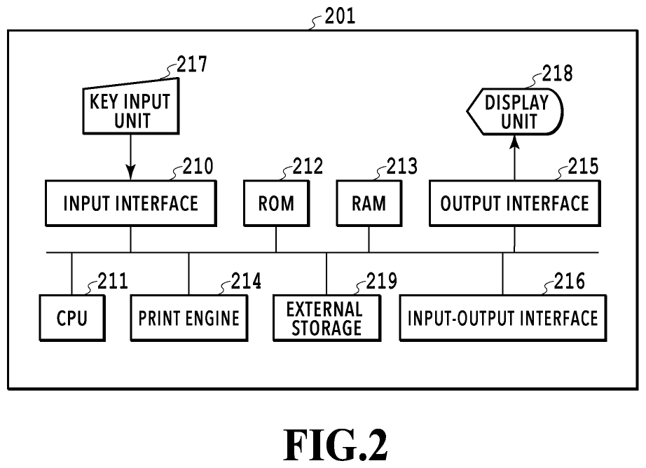

FIG. 2 is a block diagram showing a hardware configuration of the printing apparatus 201. The printing apparatus 201 includes an input interface 210, a CPU 211, a ROM 212, a RAM 213, a print engine 214, an output interface 215, an input-output interface 216, a key input unit 217, a display unit 218, an external storage 219, and the like.

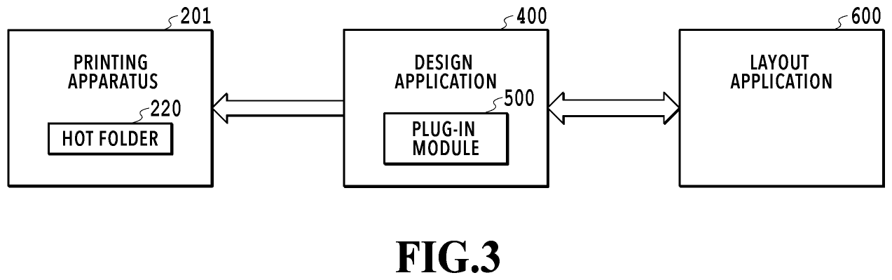

The CPU 211 functions as a control unit that controls the entire printing apparatus 201. The CPU 211 calls programs stored in the ROM 212, the external storage 219 or the like into a work area of the RAM 213 and executes the programs. The ROM 212 stores a control program to be executed by the CPU 211 and fixed data such as data tables. The RAM 213 is used as a work memory for the CPU 211 and is also used as a buffer for temporarily storing print jobs. A hot folder 220 (FIG. 3) is configured in the external storage 219 via a file system.

The hot folder 220 is a folder that stores print jobs received from the host computer 101. The printing apparatus 201 obtains the print job stored in the hot folder 220 according to a control signal from the CPU 211 and executes the print job.

The key input unit 217 includes numeral input keys, mode setting keys, a determination key, a cancel key, and the like to input a signal to the CPU 211 according to user's operation.

The display unit 218 is configured with a liquid crystal display (LCD) or the like, and displays details of print data received from the host computer 101 and the state of the printing apparatus 201 according to a control signal from the CPU 211. The display unit 218 may be a display integrated with a touch panel. In this case, the display unit 218 inputs a signal corresponding to a touch operation on the touch panel to the CPU 211.

The print engine 214 forms an image on a printing medium such as paper using a printing agent such as ink based on the data stored in the RAM 213 and a print job obtained from the host computer 101 or the hot folder 220, and discharges the printed product as the print result. In the present embodiment, a PDF file is used as the format of a print job file, but the file format is not limited thereto.

The computer 101 and the printing apparatus 201 can communicate with each other by connecting the input-output interface 116 of the computer 101 and the input-output interface 216 of the printing apparatus 201. Examples of a connection method include a network connection and the like, but the connection method is not limited thereto.

### Software Configuration of Print System

FIG. 3 is a block diagram showing a software configuration of the print system. As described above, application programs such as the design app 400 and the layout app 600 are stored in the host computer 101 of the print system.

The design app 400 is an app used to create label data to be printed by the printing apparatus 201. A designer and the like who create and edit label data use the design app 400 to create label data to be printed.

The design app 400 also has a plug-in module 500 (hereafter referred to as the plug-in) built therein. In the present embodiment, it is assumed that a plurality of different versions of design apps 400 are installed in the host computer 101. For example, a design app 400A of version 3, a design app 400B of version 2, and a design app 400C of version 1 are installed. Some of the functions differ between the versions. These three versions are referred to as version 3, version 2, and version 1 in order of latest version.

The design apps 400A, 400B, and 400C have a plug-in A, a plug-in B, and a plug-in C built therein, respectively. The design apps 400A, 400B, and 400C are referred to as the design app 400 if there is no need to distinguish between them. The plug-ins are referred to as the plug-in 500 if there is no need to distinguish between them.

The plug-in 500 starts the layout app 600 as it is called by the design app 400. The plug-in 500 and the layout app 600 then start engaging in interprocess communication. The plug-in 500 calls a different application, such as the layout app 600, using the design app 400 as a host, establishes interprocess communication between the host and the different app, and requests and responds to processing. If there is more than one host (design app 400), the plug-ins 500 built into each host (design app 400) each call the layout app 600. In this case, the CPU 111 assigns a plug-in identifier that can identify each plug-in 500.

The layout app 600 is an application for expanding the functions of the design app 400, and is called via the plug-in module 500 built into the design app 400. The layout app 600 obtains information on one or more label data created by the design app 400, and accepts operations such as label data layout, print job setting, and storing destination (hot folder 220) setting. These processes are performed by the designer or an operator of the printing apparatus 201 through an operation screen of the layout app 600 (the operation screen of the layout app 600 will be hereinafter referred to as the editing screen).

Note that the layout app 600 does not have any output functions other than preview display. For example, the layout app 600 does not have functions to write label data edited on the editing screen as data in a unique format or PDF format, to store the label data, or to output the data to the printing apparatus 201. This is because the design app 400 as the host has sufficient output functions, and the layout app 600 is an application to cover lacking functions of the design app 400. However, the layout app 600 has the function to display a preview of the label data on the editing screen.

Upon receipt of a storing (output) command after completion of the operation in the layout app 600, the layout app 600 returns the edited data generated by the operation on the editing screen to the design app 400 via the plug-in 500 and requests the output (display and write) of the print job file. The edited data includes attributes of the label data before editing, layout information, print job setting information, storing destination setting information, and the like.

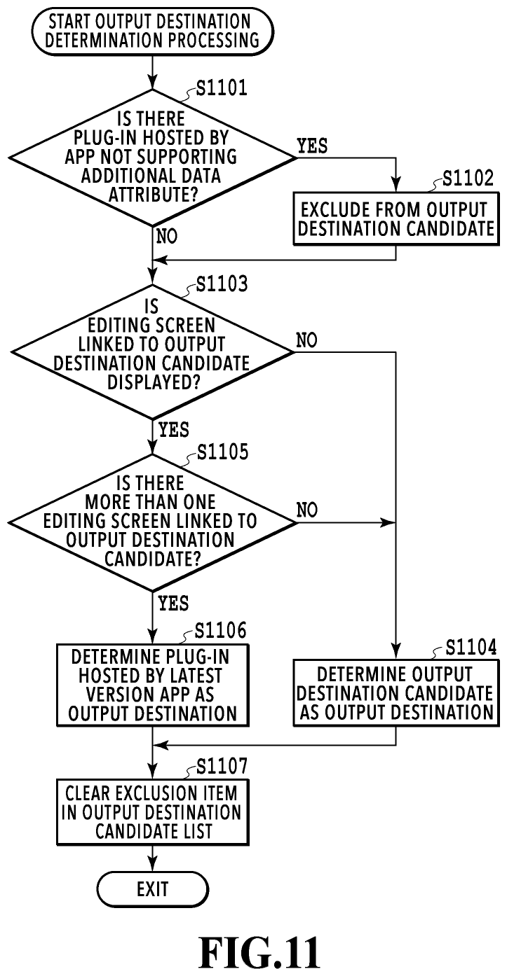

If there is more than one piece of label data to be processed and the layout app 600 is called by more than one design app 400, the layout app 600 needs to determine which host to return the data to. Therefore, the layout app 600 of the present embodiment executes output destination determination processing shown in FIG. 11 and the like.

In the first embodiment, the layout app 600 executes the output destination determination processing upon importing information on the label data to be processed. In a case of displaying the data to be processed on the editing screen, the plug-in 500 determined in the output destination determination processing is associated with the editing screen. The output destination determination processing will be described in detail later.

Upon receipt of a request from the layout app 600 via the plug-in 500 to output a print job file, the design app 400 performs output processing in response to the request. Specifically, upon receipt of the edited label data such as attribute information, layout information, and print job setting for the processed label data from the layout app 600, the design app 400 displays the edited label data according to the layout information. The design app 400 also writes the edited label data in a format (such as PDF) that can be transmitted to the printing apparatus 201 based on the set information, and transmits the data to the hot folder 220 configured in the external storage 219 of the printing apparatus 201.

When the PDF data is stored in the hot folder 220, the printing apparatus 201 prints the edited label data using print settings preset in the hot folder 220.

### Software Configuration of Design App 400

The functions (software configuration) of the design app 400 will now be described.

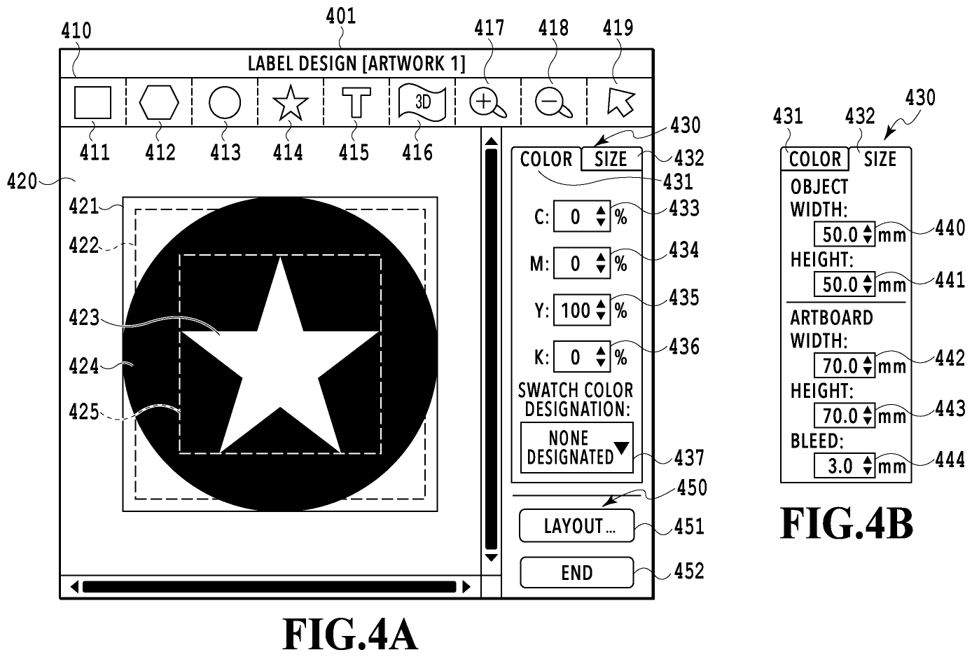

FIGS. 4A and 4B show an example of a screen 401 of the design app 400. The screen 401 includes a menu bar section 410, a preview section 420, a property setting section 430, a processing selection section 450.

The menu bar section 410 has the following menu items. A rectangle menu 411, as it is selected by the user, allows a rectangular object to be drawn on an artboard to be described later, with a specified size and a specified color. Similarly, a polygon menu 412, a circle menu 413, a star menu 414, and the like are provided to enable objects of the respective shapes to be drawn on the artboard to be described later, with a specified size and a specified color.

A text menu 415, as it is selected by the user, allows a text object to be drawn on the artboard in a specified size and a specified color. As a 3D menu 416 is selected with an existing object selected, the selected object is drawn in a pseudo three-dimensional manner.

The pseudo three-dimensional drawing function is a unique function of the design app 400A of version 3, and other drawing apps and some versions (version 1 and version 2) of the design app 400 do not support this function. However, in a case where label data including an object set with the pseudo three-dimensional drawing function is converted to a general-purpose data format such as PDF, the target object is converted into image data that is drawn in a pseudo three-dimensional manner. The converted image data can be handled as a PDF file by the other drawing apps and the other versions.

Selecting a zoom-in menu 417 increases the display magnification of the preview section 420. Selecting a zoom-out menu 418 reduces the display magnification of the preview section 420. Selecting an object selection menu switches a mouse pointer to an object selection mode, making it possible to select an object in the preview section 420.

Label data created by the design app 400 is displayed in the preview section 420. A dashed line 422 indicates an artboard area, and a solid line 421 indicates a bleed area. Here, the export data of the design app 400 is a target object to be drawn that fits in the bleed area 421. The artboard area 422 inside the bleed area 421 is an area that represents the finished size of the label data. After printing, the label data is cut by a die cut machine. In consideration of positional deviation in die cutting, the label data has the bleed area 421 provided outside the finished size.

The label data displayed in the preview section 420 in FIG. 4A is drawn by combining an object 423 drawn with the star menu 414 and an object 424 drawn with the circle menu 413. A dashed line 425 is an object selection frame, indicating a state where the object 423 is selected in this example.

The property setting section 430 includes a color menu tab 431 and a size menu tab 432. As the color menu tab 431 is selected, color setting fields 433 to 437 are displayed in the property setting section 430 as shown in FIG. 4A, and attributes related to the color of the selected object can be set.

The setting fields 433 to 436 are for cyan setting, magenta setting, yellow setting, and black setting, respectively, where a value between 0% and 100% can be entered, to accept the setting of the percentage of cyan, magenta, yellow, and black of the selected object. The setting field 437 is for swatch color designation to accept the designation of a particular color of the selected object.

As options for the swatch color designation 437, a list of color sample identifiers of a color sample book provider called a swatch color library that is supported by the design app is displayed besides “none designated”. If a color sample identifier is selected in the swatch color designation 437, the cyan setting 433, magenta setting 434, yellow setting 435, and black setting 436 can no longer be set. If “none designated” is selected in the swatch color designation 437, on the other hand, the cyan setting 433, magenta setting 434, yellow setting 435, and black setting 436 can be set.

As the size menu tab 432 is selected, size setting fields 440 to 444 are displayed in the property setting section 430 as shown in FIG. 4B. This makes it possible to configure the setting of attributes related to the size of the selected object, as well as the setting of the artboard area 422 and the bleed area 421. The object field has a width setting 440 and a height setting 441 to accept the setting of the width and height of the selected object.

The artboard field width setting 442 accepts the setting of the finished size width of the label data, which corresponds to the width of the artboard area 422. The artboard field height setting 443 accepts the setting of the finished size height of the label data, which corresponds to the height of the artboard area 422. The artboard field bleed setting 444 accepts the setting of the bleed area 421 based on the artboard area 422. That is, based on the artboard area 422, the area outside the size specified in the artboard bleed setting 444 becomes the bleed area 421.

The processing selection section 450 includes a layout processing button 451 and an end button 452. As the end button 452 is operated, the CPU 111 closes the window 401 of the design app 400 to end the design app 400. As the layout processing button 451 is operated, the design app 400 calls the plug-in 500 and requests the layout app 600 to execute label data addition processing to be described later.

### Relationship Between Plug-in and Each Application

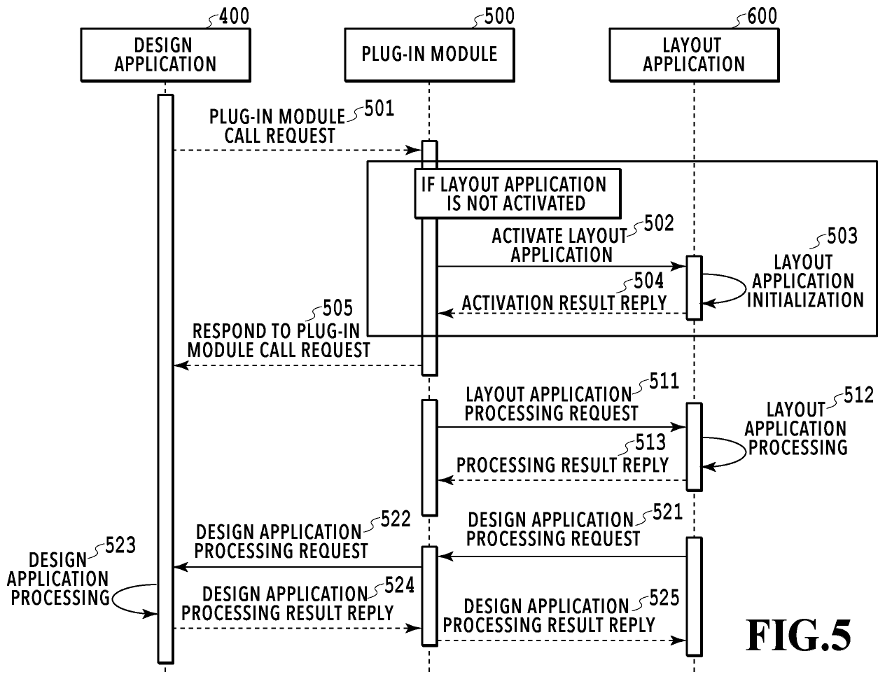

FIG. 5 is a processing sequence diagram showing the calling relationship between the plug-in 500, the design app 400 as the host application (caller), and the layout app 600 as the callee.

First, the plug-in 500 receives a plug-in calling request (501) from the design app 400 as the layout processing button 451 of the design app 400 is operated. If the layout app 600 is not activated, the plug-in 500 activates the layout app 600 (502).

The layout app 600, once activated, executes initialization processing (503) to establish interprocess communication with the plug-in 500, using the interprocess communication function provided by the OS. Once the interprocess communication is established, the layout app 600 responds to the plug-in 500 with the activation result through the interprocess communication (504). Thereafter, the plug-in 500 and the layout app 600 use the established interprocess communication to make requests and responses. In response to calling the plug-in 500, the plug-in 500 then responds to the design app 400 as the caller (505).

If the layout app 600 is already activated upon receipt of the plug-in calling request (501) from the design app 400, the plug-in 500 has the interprocess communication already established with the layout app 600. Therefore, the processing of 502 to 504 is omitted, and the plug-in 500 makes a response (505) to the calling of the plug-in 500 (505).

Next, in a case where the plug-in 500 requests the layout app 600 to perform processing, the plug-in 500 sends a layout app processing request (511) to the layout app 600 through the interprocess communication (511). Upon receipt of the processing request from the plug-in 500, the layout app 600 performs processing within the layout app 600 based on the processing request (512) and responds to the plug-in 500 with the processing result through the interprocess communication (513).

In a case of making a processing request for the design app 400, the layout app 600 sends a design app processing request to the plug-in 500 through the interprocess communication (521). Upon receipt of the design app processing request from the layout app 600, the plug-in 500 requests the design app 400 to perform design app processing (522).

Upon receipt of the processing request from the plug-in 500, the design app 400 performs processing within the design app 400 based on the processing request (523) and responds to the plug-in 500 with the processing result (524). Upon receipt of the processing result from the design app 400, the plug-in 500 responds to the layout app 600 with the design app processing result through the interprocess communication (525).

As described above, the plug-in 500 realizes the processing requests and responses between the plug-in 500 and the layout app 600 through the interprocess communication established with the layout app 600. The plug-in 500 also realizes proxy processing requests and proxy responses between the layout app 600 and the design app 400. In the following description, the description of such processing of the plug-in 500 using the interprocess communication will be omitted.

The plug-in 500 can be built into more than one version of design app 400, and establishes interprocess communication with the layout app 600 in the activation process for each version of the design app 400 recognized by the OS. As the interprocess communication with the layout app 600 is established, the plug-in 500 notifies the layout app 600 of a plug-in identifier that is unique on the OS.

### Label Data Addition Processing

As described above, the layout app 600 is activated via the plug-in 500 as the layout processing button 451 is operated during execution of the design app 400. The plug-in 500 requests the layout app 600 to execute label data addition processing immediately after the design app 400 is activated or as the layout processing button 451 of the design app 400 is operated.

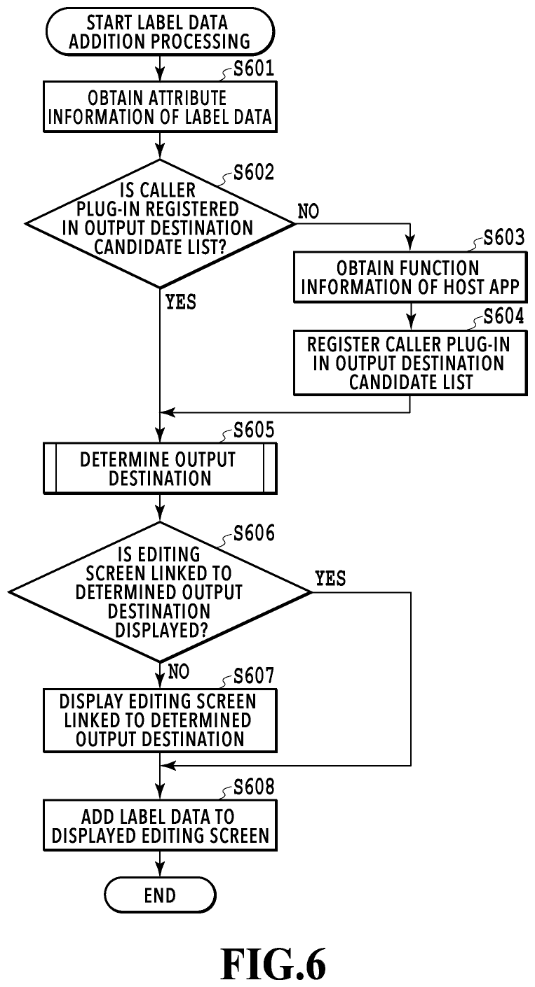

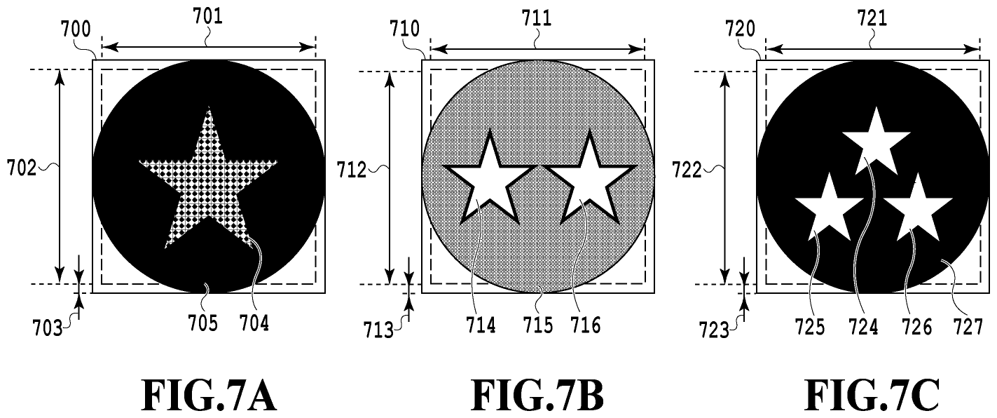

FIG. 6 is a flowchart showing a flow of the label data addition processing. The label data addition processing is executed by the layout app 600, and is started as the label data addition processing is requested by the plug-in 500. Before execution of the label data addition processing, three types of label data 700, 710, and 720 shown in FIGS. 7A to 7C are created with the design app 400.

The label data 700 shown in FIG. 7A is label data created with the design app 400A of “version 3”. The artboard width setting 442 is set to 70.0 mm, and the finished size width 701 is set to 70.0 mm. The artboard height setting 443 is set to 70.0 mm, and the finished size height 702 is set to 70.0 mm. The artboard bleed setting 444 is set to 3.0 mm, and the bleed area 703 is set to 3.0 mm.

An object 704 of the label data 700 is a star-shaped object created with the star menu 414, and the yellow ratio is set to 100% with the yellow setting 435. The object is also drawn in a pseudo three-dimensional manner by selecting the 3D menu 416. An object 705 is a circle object created with the circle menu 413, and the black ratio is set to 100% with the black setting 436.

The label data 710 shown in FIG. 7B is label data created with the design app 400B of “version 2”. The artboard width setting 442 is set to 70.0 mm, and the finished size width 711 is set to 70.0 mm. The artboard height setting 443 is set to 70.0 mm, and the finished size height 712 is set to 70.0 mm. The artboard bleed setting 444 is set to 3.0 mm, and the bleed area 713 is set to 3.0 mm.

Objects 714 and 716 of the label data 710 are star-shaped objects created with the star menu 414, and a particular color BBB-Yellow from a BBB swatch color library is set with the swatch color designation 437. The object 715 is a circle object created with the circle menu 413, and the black ratio is set to 15% with the black setting 436.

The label data 720 shown in FIG. 7C is label data created with the design app 400C of “version 1”. The artboard width setting 442 is set to 70.0 mm, and the finished size width 721 is set to 70.0 mm. The artboard height setting 443 is set to 70.0 mm, and the finished size height 722 is set to 70.0 mm. The artboard bleed setting 444 is set to 3.0 mm, and the bleed 723 is set to 3.0 mm.

Objects 724, 725, and 726 are star-shaped objects created with the star menu 414, and the yellow ratio is set to 100% with the yellow setting 435. An object 727 is a circle object created with the circle menu 413, and the black ratio is set to 100% with the black setting 436.

First, with reference to FIG. 6, description will be given of the label data addition processing in a case where the layout processing button 451 is operated in a state where the label data 700 is created with the design app 400A of “version 3”.

As the layout processing button 451 is operated in the design app 400A, the plug-in 500 requests the layout app 600 to execute the label data addition processing. In response to the request from the plug-in 500, the layout app 600 starts the label data addition processing shown in FIG. 6. Note that the processing shown in the following flowchart is performed by the CPU 111 of the host computer 101 calling a processing program stored in the ROM 112 or the external storage 114, expanding the program into the RAM 113, and executing the program. In the following description, the symbol “S” represents a step.

In S601, the layout app 600 requests the caller plug-in 500 to obtain attribute information of the added label data 700.

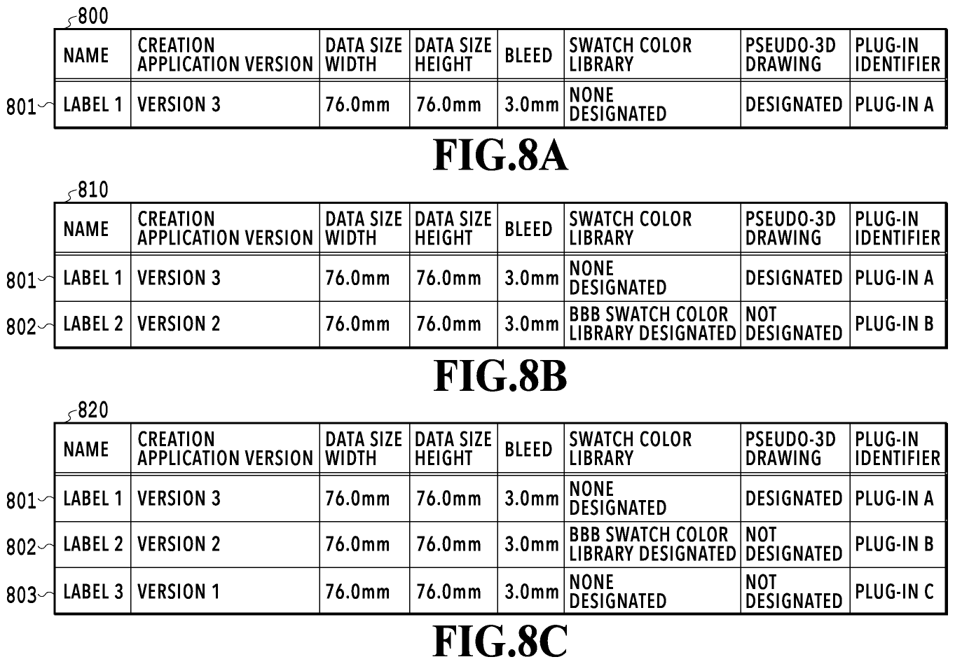

Information 800 shown in FIG. 8A is attribute information 801 obtained from the design app 400A by the layout app 600 upon addition of the label data 700.

The attribute information 801 obtained includes the name “label 1” of the label data 700, the created app version “version 3”, the data size width “76.0 mm”, the data size height “76.0 mm”, the bleed size “3.0 mm”, the swatch color library “none designated”, the pseudo-3D drawing “designated”, and the like. “Plug-in A” is also obtained as the plug-in identifier. The plug-in identifier is information used to identify the plug-in 500 that has requested the layout app 600 to execute the label data addition processing, and is notified by the layout app 600.

In S602, the layout app 600 determines whether or not the caller plug-in 500 is registered in an output destination candidate list. In this case, the caller plug-in 500 is the plug-in A.

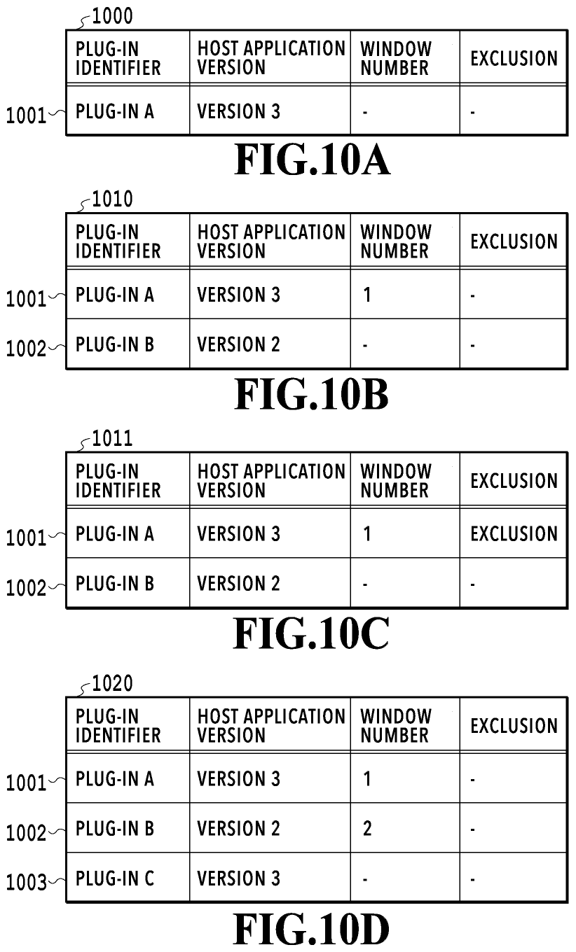

The output destination candidate list is information for determining which design app 400 hosts the plug-in 500 to which edited data generated after editing by the layout app 600 is to be returned, and candidate plug-ins are registered as output destinations. Specifically, one or more plug-ins currently calling the layout app 600 are registered as the candidates. The output destination candidate list will be described in detail later (FIGS. 10A to 10D).

At this point, the layout app 600 is requested, immediately after its activation, by the plug-in 500 to execute the label data addition processing, and thus the output destination candidate list is in its initial state (nothing registered). In this case, the layout app 600 determines in S602 that the caller plug-in 500 is not registered in the output destination candidate list (S602; NO) and proceeds to S603. If the caller plug-in 500 is registered in the output destination candidate list, the processing proceeds to S605.

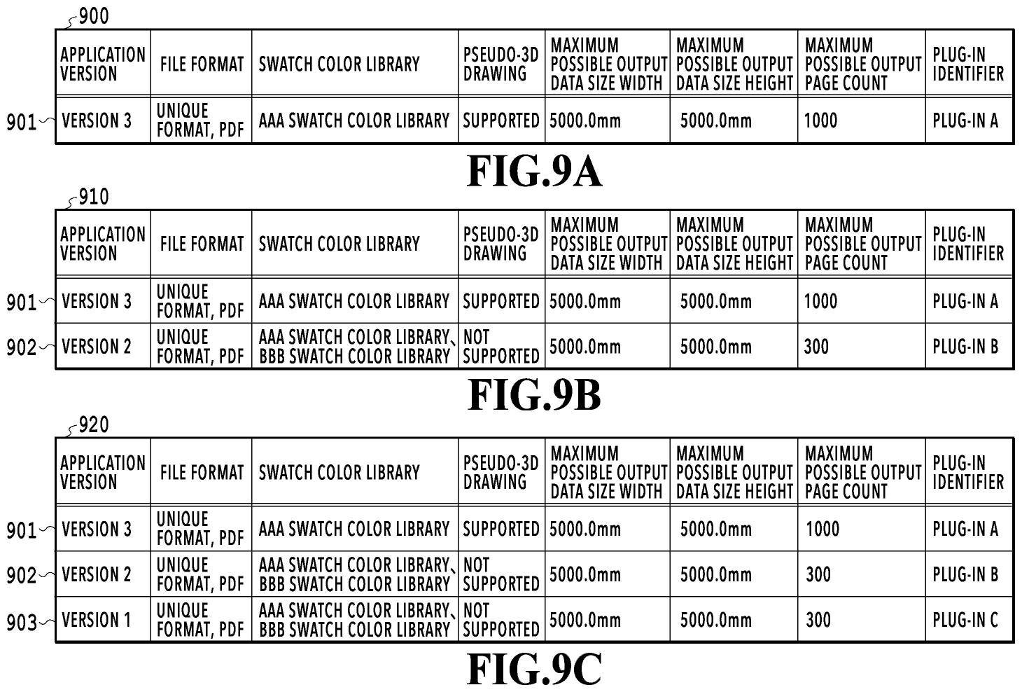

In S603, the layout app 600 obtains function information on the design app 400A as the host of the caller plug-in (plug-in A). It is assumed here that function information 900 shown in FIG. 9A is obtained.

As shown in FIG. 9A, the version information of the host app, supported file format, supported swatch color library, pseudo-3D drawing support, maximum output data size (width, height, page count), and the like are obtained as the function information 900.

The function information 901 obtained at this point includes the app version “version 3”, file format “unique format” and “PDF”, swatch color library “AAA swatch color library”, pseudo-3D drawing function “supported”, maximum output data size width “5000.0 mm”, maximum output data size height “5000.0 mm”, and maximum output page count “1000”. “Plug-in A” is also obtained as the plug-in identifier. This indicates that the function information 901 shows the functions of the host app with the identifier “plug-in A”.

In S604, the layout app 600 registers the information of the caller plug-in 500 in the output destination candidate list, and proceeds to S605.

FIGS. 10A to 10D are diagrams showing the output destination candidate list managed by the layout app 600. The output destination candidate list has the following items in association with the identifier of the plug-in 500: host application version information, window number information, and information indicating whether to exclude from the output destination candidates.

In an output destination candidate list 1000 of FIG. 10A, which is generated upon addition of label data A, the plug-in identifier “plug-in A”, app version “version 3”, window number “-”, and exclusion “-” are registered.

In the item “window number”, in a case where the layout app 600 is displaying an editing screen, a number that identifies the editing screen is registered. If the editing screen is not displayed, “-” is registered. If more than one editing screen is opened, different values such as “1”, “2”, . . . are registered in the item “window number”.

In the first embodiment, in a case of opening an editing screen, association (also referred to as “linking”) of the output destination of edited data, which is edited on the editing screen, is performed by the layout app 600. FIG. 10A shows an example of a state where the output destination candidate list 1000 is generated (immediately after activation). Therefore, the layout app 600 displays no window linked to the plug-in A, and thus “-” is registered.

The item “exclusion” is information indicating whether to exclude the target plug-in from the output destination candidates in the processing after S605. For example, the attribute information obtained in S601 is compared with the function information of the host of the target plug-in. If the host of the target plug-in does not support the function of the added label data, the target plug-in is excluded from the output destination candidates. The plug-in A is not excluded from the output destination candidates upon creation of the output destination candidate list 1001 in FIG. 10A, and thus “-” is registered. If the target plug-in is excluded from the output destination candidates, “excluded” is registered.

### Output Destination Determination Processing

In S605, the layout app 600 executes output destination determination processing.

FIG. 11 is a flowchart showing a flow of the output destination determination processing.

In S1101, the layout app 600 determines whether the output destination candidate list 1000 includes a plug-in hosted by an app that does not support the attributes of the added label data (hereinafter referred to as additional data). Here, the layout app 600 compares the attribute information 801 of the label data 700, which is the additional data, with the function information 901 on the host of the plug-in registered in the output destination candidate list 1000, and determines whether there is a plug-in that cannot be supported by the functions of the host.

Since the plug-in A is registered in the output destination candidate list 1000, the function information 901 of the host is compared with the attribute information 801 of the label data 700 as the additional data. With reference to FIGS. 8A and 9A, there is no function in the function information 901 that cannot be supported for the attribute information 801 of the label data 700. Therefore, the determination result in S1101 is NO and the processing proceeds to S1103. If any of the plug-ins in the output destination candidate list is hosted by an app that cannot support the attribute information of the additional data (S1101; YES), the layout app 600 proceeds to S1102.

In S1102, the layout app 600 excludes the plug-in hosted (called) by the non-supporting app from the output destination candidate list.

In S1103, the layout app 600 determines whether the editing screen (window of the layout app 600) linked to the plug-in (plug-in A) in the output destination candidate list is displayed. The layout app 600 refers to the “window number” in the output destination candidate list 1000 shown in FIG. 10A. Since “-” is registered in the “window number”, it is understood that the editing screen associated with the plug-in A is not displayed (S1103; NO). The processing proceeds to S1104 if the editing screen is not displayed, and proceeds to S1105 if the editing screen is displayed.

In S1104, the layout app 600 determines the plug-in A in the output destination candidate list as the plug-in 500 for outputting the edited data.

In S1105, on the other hand, the layout app 600 determines whether or not there is more than one editing screen linked to the plug-in as the output destination candidate. It is determined in S1105 whether or not there is more than one plug-in registered in the current output destination candidate list and not excluded, for which the editing screen is already displayed. If there is more than one plug-in, the processing proceeds to S1106. If there is only one plug-in (S1105; NO), the layout app 600 proceeds to S1104.

In S1106, the layout app 600 determines that the plug-in with the latest host app version, among the plurality of output destination candidate plug-ins for which the editing screen is displayed, is the output destination of the edited data, and proceeds to S1107.

The reason why the latest version is set as the output destination is that, for applications with the same functions, newer versions are considered to be more stable. Upon determination of the latest version, the layout app 600 refers to the item “host app version” in the output destination candidate list.

In S1107, the layout app 600 performs clearing processing to change all the items in “exclusion” in the output destination candidate list to “-”, and ends this flowchart. The reason for performing the clearing processing is to set all the target plug-ins back to a non-excluded state in order to perform the next and subsequent determination in S1101.

### Display Processing of Editing Screen of Layout App 600

Once the output destination plug-in (host app) is determined in the output destination determination processing shown in FIG. 11, the layout app 600 proceeds to S606 in FIG. 6.

In S606, the layout app 600 determines whether or not the editing screen linked (associated) with the output destination is displayed. Whether or not the editing screen associated with the output destination is displayed can be checked by referring to the value in the item “window number” in the output destination candidate list. It can be determined that the editing screen is displayed if a value such as “1” or “2” is registered in the item “window number” of the target plug-in, and that the editing screen is not displayed if the window number is “-”. By linking the editing screen to the output destination (plug-in), the edited data edited on the editing screen is returned to the host app (design app 400) via the linked plug-in.

With reference to FIG. 10A, since the window number associated with the plug-in A determined as the output destination of the edited data is “-”, it is determined that the editing screen linked to the determined output destination is not displayed (S606; NO). If the editing screen linked to the determined output destination is not displayed, the processing proceeds to S607. If the editing screen linked to the determined output destination is displayed, the processing proceeds to S608.

In S607, the layout app 600 displays the editing screen in association with the determined output destination, and proceeds to S608. Here, the editing screen linked to the plug-in A determined in the output destination determination processing of S605 is displayed. The window number of the plug-in A (1001) in the output destination candidate list 1000 is also changed from “-” to “1” to indicate that the editing screen is displayed. Note that the window number may be any unique number that is greater than or equal to 1, and may be any unique number that is not used in the item “window number” of the output destination candidate list.

In S608, the layout app 600 adds label data to the currently displayed editing screen (linked to the plug-in), and ends the label data addition processing. Here, the layout app 600 adds the label data 700, which is additional data, to the editing screen linked to the plug-in A, and ends the label data addition processing.

In S608, the format of the label data added to the editing screen by the layout app 600 is the unique format of the original design app 400. In the following description, unless otherwise specified, the format of the label data to be added is the unique format of the design app 400.

### Software Configuration of Layout App

Here, the functions (software configuration) of the layout app 600 will be described.

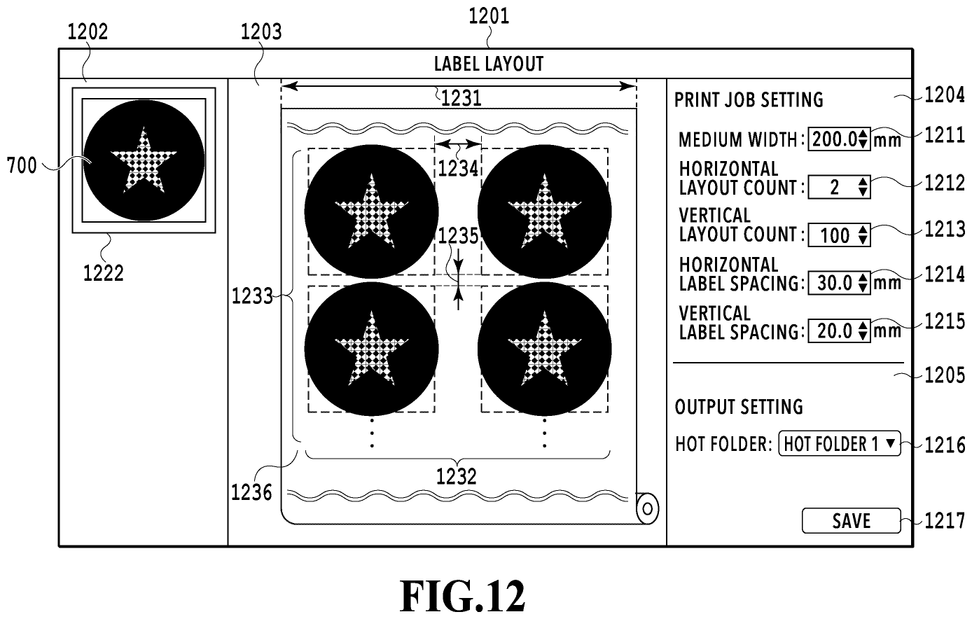

FIG. 12 shows an example of an editing screen 1201 of the layout app 600. The editing screen 1201 is a window linked to the plug-in determined as the output destination. The editing screen 1201 includes a label data selection section 1202, a preview section 1203, a job setting section 1204, an output setting section 1205, and the like.

In the label data selection section 1202, one or more label data added to be edited are displayed in a thumbnail list format so that they can be selected. In FIG. 12, the added label data 700 is selected in a selection frame 1222. The preview section 1203 is an area where a preview of the layout is displayed, in which the label data is to be printed on the printing medium in the printing apparatus 201. This preview display is displayed based on the setting content in the job setting section 1204.

A medium width 1211 in the job setting section 1204 accepts the setting of the width of the printing medium on which printing is performed by the printing apparatus 201. A range 1231 shown in the preview section 1203 is displayed corresponding to the medium width 1211. The label data is positioned based on the finished size determined in the design app 400. In the case of the label data 700, the positioning is performed on the editing screen 1201 of the layout app 600, based on the finished size width 701 and height 702 (FIG. 7A).

A horizontal layout count 1212 and a vertical layout count 1213 in the job setting section 1204 accept settings for how many pieces of label data are to be laid out in horizontal and vertical directions. Reference numerals 1232 and 1233 in the preview section 1203 correspond to the horizontal layout count 1212 and the vertical layout count 1213, respectively. Labels lined up vertically can be displayed using a scroll bar or other method that allows visual confirmation that a specified number of pieces of label data are lined up vertically. The vertical layout count 1213 is the number of copies to be printed, and is the page count of the edited data. That is, in the edited data, the data laid out horizontally in the preview section 1203 is treated as one page.

A horizontal label spacing 1214 in the job setting section 1204 is for setting the spacing between adjacent labels, and corresponds to reference numeral 1234 in the preview section 1203. A vertical label spacing 1215 is for setting the spacing between upper and lower labels, and corresponds to reference numeral 1235 in the preview section 1203.

The label data is laid out vertically. As the user drags and drops selected label data into the label layout area of the preview section 1203, a column of label data laid out vertically is all replaced with the selected label data.

A selection field 1216 is a hot folder selection field, and displays a list of pre-registered hot folders 220 of the printing apparatus 201.

A button 1217 is operated to output (return to the design app) and save the edited data. When this “Save” button 1217 is operated, the layout app 600 requests the plug-in 500 linked to the editing screen 1201 to perform save processing. The save processing is for writing and sending (saving) the edited data, in which the label data is laid out, in a format such as a PDF file it to the hot folder 220 specified in the hot folder selection 1216.

The plug-in 500 (plug-in A) linked to the editing screen 1201 requests the design app 400 to save the edited data in response to the save processing request from the layout app 600. The edited data is information obtained by adding to the added label data 700 the information such as the medium width 1211, horizontal layout count 1212, vertical layout count 1213, horizontal label spacing 1214, and vertical label spacing 1215, and information such as a save destination, which are set in the print job setting section 1204.

More specifically, in a case of outputting (saving) the edited data, the layout app 600 makes the following request to the plug-in A. In the design app 400, new data is created in a specified size so that the label data to be edited has a size and coordinates according to the layout information set in the print job setting 1204. Each piece of label data is placed at the specified coordinates and outputted as a PDF file to the specified hot folder.

The label data 700 is created with the design app 400 of “version 3”, and the host app of the plug-in A making the output request is also the design app 400A of “version 3”. Therefore, if a request is made to output the edited data, the attributes set in the output data (label data 700) correspond to the functions of the output destination app, making it possible to output a desired result.

### Adding More Than One Piece of Data to be Edited

Next, description will be given of a case of adding more than one piece of label data to be edited to the layout app 600.

It is assumed that the editing screen 1201 linked to the plug-in A is currently displayed, and the label data 700 is added to be edited. Furthermore, the attribute information 801 of the label data 700 and the function information 901 of the original design app 400A are obtained by the first label data addition processing described above.

It is also assumed that the plug-in A is registered in the output destination candidate list, “version 3” is registered in the item “host app version”, “1” is registered in the item “window number”, and “-” is registered in the item “exclusion” (FIGS. 8A, 9A, and 10A).

In this state, it is assumed that the label data 710 is created with the design app 400B of “version 2” and the layout processing button 451 is operated. The layout app 600 is requested to perform the label data addition processing (FIG. 6) by the plug-in B built into the design app 400B.

In response to the request, the layout app 600 executes label data addition processing.

In S601, the layout app 600 requests the caller plug-in B to obtain attribute information of the label data 710 as the additional data. FIG. 8B shows attribute information 810 obtained by the layout app 600. As shown in FIG. 8B, in addition to the attribute information 801 of the label data 700, attribute information 802 of the label data 710 to be added this time is obtained.

In S602, the layout app 600 determines whether or not the caller plug-in B is registered in the output destination candidate list. The caller plug-in B is not yet registered in the output destination candidate list because the host app 400 version thereof is different from that of the caller plug-in A in the previous processing (S602; NO), and thus the layout app 600 proceeds to S603.

In S603, the layout app 600 sends a request to obtain function information to the design app 400B, which is the host app of the caller plug-in B, and obtains the function information. As shown in FIG. 9B, function information 902 of the host app of the plug-in B is newly obtained.

In S604, the layout app 600 registers the caller plug-in B in the output destination candidate list, and proceeds to S605. As shown in candidate information 1002 in FIG. 10B, the plug-in identifier “B” and version information “version 2” are added.

In S605, the layout app 600 executes the output destination determination processing shown in FIG. 11.

In S1101 of FIG. 11, the layout app 600 compares the attribute information 802 of the label data 710 as the additional data with the host app function information 901 and 902 obtained thus far. The layout app 600 then checks if there is a plug-in hosted by an app that does not support the attribute information 802 of the additional data.

The attribute information 802 of the label data 710 as the additional data includes “BBB swatch color library” as shown in FIG. 8B. Referring to the function information 910 shown in FIG. 9B, the function information 901 of the plug-in A does not include “BBB swatch color library”. Therefore, the host app (design app 400A) of the plug-in A cannot support the label data 710. The layout app 600 thus determines in S1101 that there is a plug-in hosted by an app that does not support the attributes of the additional data (S1101; YES), and proceeds to S1102.

In S1102, the layout app 600 excludes the plug-in (plug-in A) hosted by the app that does not support the attributes of the additional data from the output destination candidates. Then, the item “exclusion” for the plug-in A is changed from “-” to “excluded” as in the output destination candidate list 1011 shown in FIG. 10C. That is, the plug-in B is the only output destination candidate.

In S1103, the layout app 600 determines whether the editing screen linked to the plug-in 500 as the output destination candidate is displayed. Referring to the output destination candidate list 1011 at this point (FIG. 10C), the item “window number” of the plug-in B as the output destination candidate that is not excluded is “-”. Therefore, it is determined that the editing screen linked to the plug-in B is not yet displayed (S1103; NO), and the processing proceeds to S1104.

In S1104, the layout app 600 determines that the plug-in B is the plug-in 500 for outputting the edited data including the label data 710, and proceeds to S1107.

In S1107, the layout app 600 executes clearing processing, ends this flowchart, and returns to S606 in FIG. 6.

In S606, the layout app 600 checks if the editing screen linked to the output destination (plug-in B) determined by the output destination determination processing is displayed. As shown in FIG. 10C, since “-” is registered in the item “window number” for the plug-in B in the output destination candidate list 1011, it is determined that the editing screen linked to the plug-in B is not yet displayed (S606; NO), and the processing proceeds to S607.

In S607, the layout app 600 displays the editing screen linked to the plug-in B. In order to record that the editing screen linked to the plug-in B is displayed, a new number “2” is set in the item “window number” for the plug-in B in the output destination candidate list 1011.

In S608, the layout app 600 adds (displays) the label data 710 as the additional data to the editing screen for the plug-in B displayed in S607, and ends the label data addition processing.

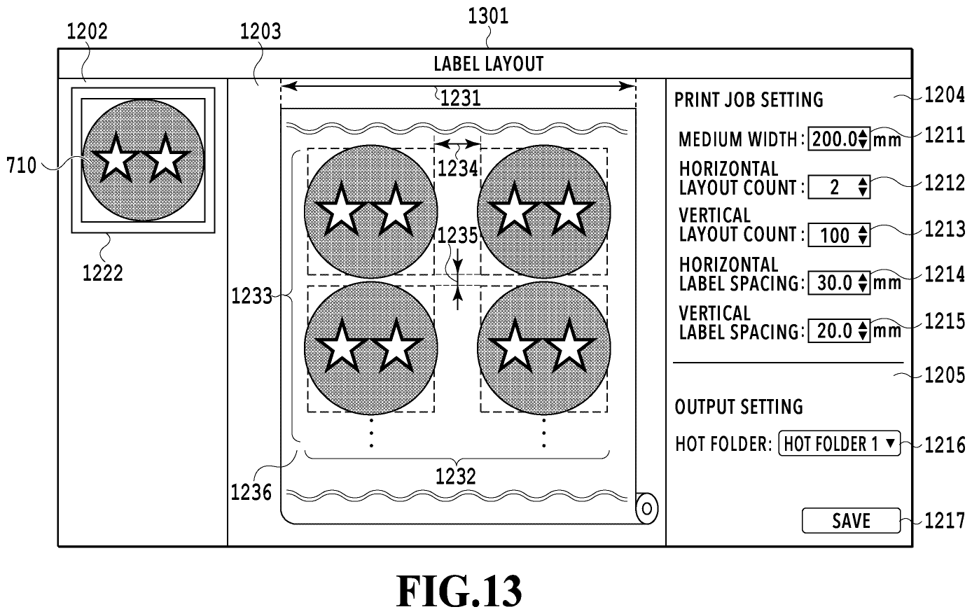

FIG. 13 shows an example of a screen (editing screen 1301) of the layout app 600 in a state where the label data 710 is added. The editing screen 1301 is a window linked to the plug-in B, in which the added label data 710 is selected in a selection frame 1222.

The label data 710 is created with the design app 400B of “version 2”, and the host app of the plug-in B linked to this editing screen 1301 is also the design app 400B. Therefore, the edited data edited on this editing screen 1301 can also be supported by the functions of the output destination design app 400B, thus making it possible to output a desired result to the design app 400B.

In a case where the label data is laid out and a print job is set on the editing screen 1301 linked to the plug-in B, and the save button 1217 is operated, the layout app 600 sends an output request to the plug-in B linked to the editing screen 1301. In response to the output request, the plug-in B sends an output request to the design app 400B of “version 2” as the host app. The design app 400B of “version 2” then executes output processing.

### Adding Third Label Data 720

The processing thus far causes the display unit 119 of the host computer 101 to display the editing screen 1201 for the plug-in A and the editing screen 1301 for the plug-in B. The RAM 113 holds the attribute information 810 shown in FIG. 8B and the function information 910 shown in FIG. 9B, and the information 1001 about the plug-in A and the information 1002 about the plug-in B as shown in FIG. 10C are registered in the output destination candidate list 1011.

However, in the item “window number” of the output destination candidate list 1011, “1” is registered for the plug-in A and “2” is registered for the plug-in B, and “-” is registered in the item “exclusion” for both plug-ins A and B.

Next, it is assumed that label data 720 is created with the design app 400C of “version 1” and the layout processing button 451 is operated. The layout app 600 is requested to execute label data addition processing by the plug-in C built into the design app 400C. The layout app 600 makes a request to obtain attribute information of additional data, as in the previous label data addition processing. As shown in FIG. 8C, attribute information 803 of the label data 720 is newly obtained.

In S602, the layout app 600 determines whether or not the caller plug-in C is registered in the output destination candidate list. The “plug-in C” is not registered at this point in the output destination candidate list (S602; NO), and thus the processing proceeds to S603.

In S603, the layout app 600 obtains function information of the design app 400C of “version 1”, which is the host app of the caller “plug-in C”. As shown in FIG. 9C, function information 903 of the design app 400C of “version 1” is newly obtained.

In S604, the layout app 600 adds the caller plug-in C to the output destination candidate list, and proceeds to S605. As shown in the output destination candidate list 1020 in FIG. 10D, the plug-in identifier “plug-in C” and the host app version information “version 3” are additionally registered as information 1003 about the plug-in C.

In S605, the layout app 600 executes the output destination determination processing shown in the flowchart of FIG. 11.

In S1101, the layout app 600 compares the attribute information 803 (FIG. 8C) of the label data 720 as the additional data with the host app function information 901, 902, and 903 (FIG. 9C) obtained thus far. The layout app 600 then determines whether there is a plug-in hosted by an app that does not support the attributes of the additional data. The attribute information 803 of the label data 720 as the additional data can be supported by all of the function information 901, 902, and 903 shown in FIG. 9C.

Therefore, it is determined that there are no candidates to be excluded from the output destination candidate list 1020, and the processing proceeds to S1103. This means that the label data 720 as the additional data can be supported by any of the host apps of the plug-ins A, B, and C.

In S1103, the layout app 600 refers to the output destination candidate list 1020 obtained at this point, and determines whether an editing screen linked to any of the registered plug-ins A, B, and C is displayed. Since the item “window number” in the output destination candidate list 1020 indicates that the plug-ins A and B are displayed (S1103; YES), the processing proceeds to S1105.

In S1105, the layout app 600 determines whether there is more than one editing screen displayed, which is linked to the output destination candidate plug-ins. As described above, since two editing screens, one for the plug-in A and one for the plug-in B, are displayed, it is determined that there is more than one editing screen displayed (S1105; YES), and the processing proceeds to S1106.

In S1106, the layout app 600 determines, as the output destination, the one with the latest host app version among the output destination candidate plug-ins A and B, for which the editing screens are displayed. Here, the plug-in A, which is called by the host app of latest “version 3”, is determined as the output plug-in for the additional data (label data 720).

In S1107, the layout app 600 executes clearing processing and ends the output destination determination processing. The processing then proceeds to S606 in FIG. 6.

In S606, the layout app 600 checks the output destination candidate list 1020 and checks if the editing screen for the plug-in A, which is the output destination determined by the output destination determination processing in S605, is displayed. With reference to FIG. 10D, which shows the current output destination candidate list 1020, “1” is registered in the “window number” of the plug-in A. It is thus determined that the editing screen is displayed (S606; YES) and the processing proceeds to S608.

In S608, the layout app 600 adds the label data 720 as the additional data to the displayed editing screen for the plug-in A, and ends the label data addition processing.

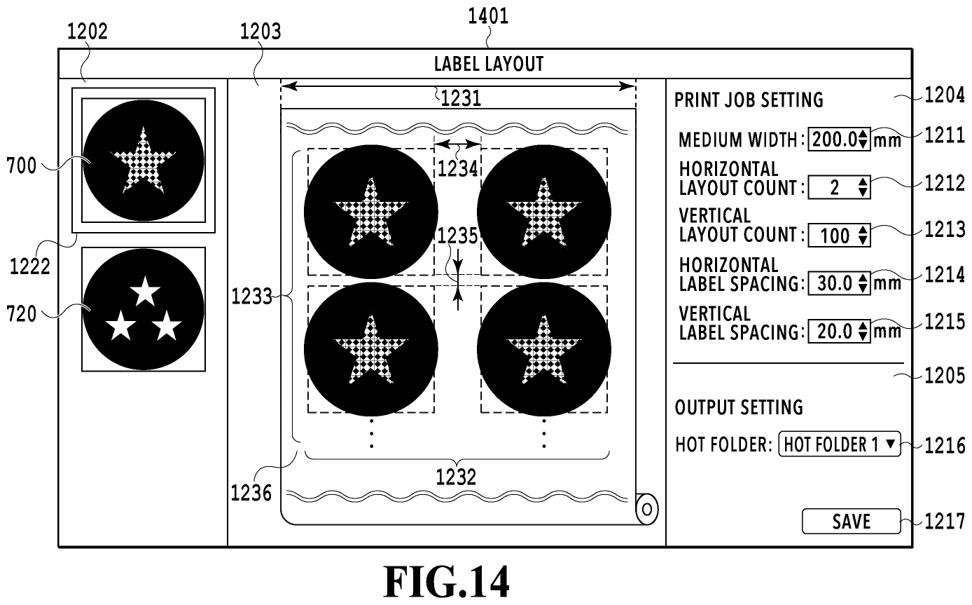

FIG. 14 shows an example of an editing screen 1401 for the plug-in A in a state where the label data 720 is added. The editing screen 1401 is a window linked to the plug-in A, showing in this example a state where the previously added label data 700 and the label data 720 added this time are displayed in the label data selection section 1202.

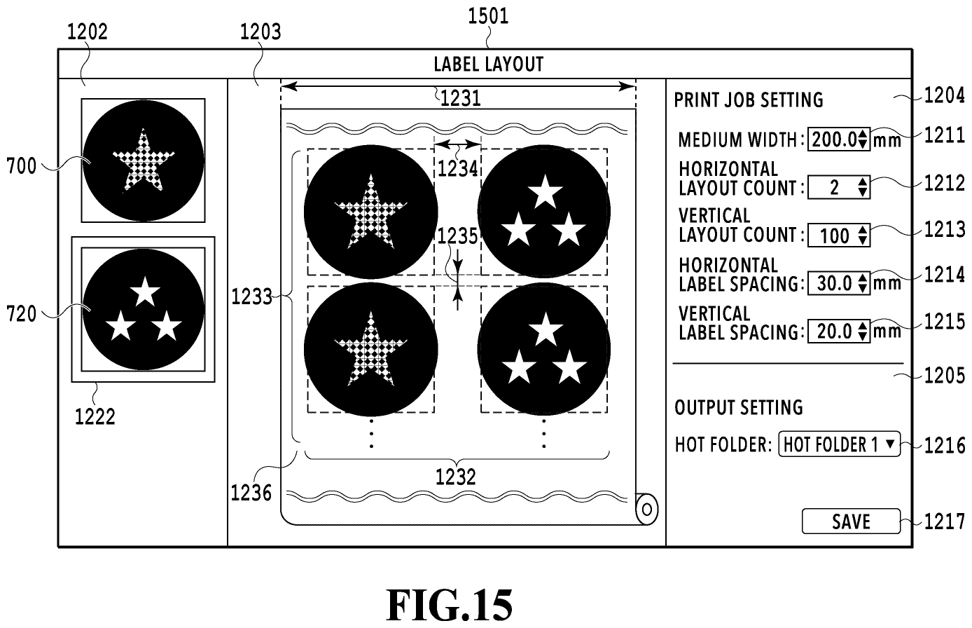

For example, as the label data 720 is selected and dragged and dropped into the label layout area of the preview section 1203, one column of labels laid out vertically is all replaced with the selected label data 720. FIG. 15 shows an example of the screen (editing screen 1501) of the layout app 600 after the above operation is executed.

The preview section 1203 of the editing screen 1501 displays a preview of label data obtained by combining the label data 700 and the label data 720, which are created with different versions. The label data 720 is created with the design app 400C of “version 1”, and the output destination is the design app 400A of “version 3” that is the host of the plug-in A. Therefore, the versions are different.

However, in the output destination determination processing, the output destination is determined so that the attribute information 801 and 803 included in the edited data can be supported by the functions (function information 901) of the output destination app. Therefore, a desired result can be outputted without compromising the attribute information 801 and 803.

As described above, according to the present embodiment, data created with the plurality of design apps 400 is processed by calling the layout app 600 via the plug-in built into each design app 400. Then, taking into consideration the attributes of the data to be processed and the functions of the host app, the output destination is determined to return the processed data again to one of the caller design apps 400. This makes it possible for the design app 400 to properly output the details of processing by the layout app 600.

More specifically, in a case of importing label data, the layout app 600 obtains attribute information of the label data and function information of the design app 400 making the layout request. Then, the layout app 600 determines the output destination plug-in so that the edited data is returned to the design app 400 having the functions corresponding to the attribute information of the added label data. This allows the design app 400 to accurately output the desired results of edited data without compromising the attributes (particular color designation information, pseudo-3D drawing support, and the like) before editing of the edited data received from the layout app 600. Note that, in the present embodiment, the function information of the design app 400 making the layout request is obtained as the label data is imported, but the timing to obtain the function information is not limited thereto. For example, the function information of the design app 400 making the layout request may be obtained in advance.

The layout app also obtains, as attribute information of the data before editing obtained from the plug-in, at least the version information of an app (for example, the design app 400) that has created the data and the version information of the function information of the app. If there is more than one candidate for the output plug-in, the layout app determines the plug-in with the latest version of the app as the host app to be the output plug-in. This makes it possible to output the edited data from the host app with more stable functions.

In the present embodiment, the description is given of the example where the layout app determines the output destination of the edited data based on the obtained attribute information of the plurality of pieces of data before editing and the function information of the host app. However, it is not necessary to compare all the information included in the attribute information and the function information, and the output plug-in may be determined by comparing only some of the information, for example, the version information.

### Second Embodiment

Next, a second embodiment of the present disclosure will be described. Note that a basic configuration of a print system of the present embodiment is the same as that of the first embodiment. Therefore, a characteristic configuration of the second embodiment will be described below. Two types of label data 700 and 710 shown in FIGS. 7A and 7B are used in the second embodiment, which are created by the design app 400 before execution of the label data addition processing (FIG. 6) in the layout app 600, as in the first embodiment. The attribute information 801 and 802 of the label data 700 and 710 are also the same as those in the first embodiment.

In the second embodiment, description will be given of a case where new label data is added while the editing screen is displayed, and the output destination linked to the displayed editing screen cannot support the attributes of the added data. In this case, the layout app 600 accepts the selection of the output destination of the added data by the user. In this event, the layout app 600 identifies attributes that cannot be supported by the output destination host app, and notifies the user to this effect. The flow of processing will be described below.

### Adding First Label Data 700

First, it is assumed that the label data 700 is created with the design app 400A of “version 3” as the first additional data, and the layout processing button 451 is operated on the screen 401 of the design app 400A. This operation requests the layout app 600 to add label data via the plug-in A of the design app 400A, and the layout app 600 executes the label data addition processing shown in FIG. 6.

In the label data addition processing in the second embodiment, since all steps except for the output destination determination processing in S605 are the same as those in the first embodiment, description thereof will be omitted, and only a difference S605 will be described. Note that the attribute information 801 of the additional data obtained in S601 is the same as that shown in FIG. 8A, and the function information 901 of the host app obtained in S603 is the same as that shown in FIG. 9A. The output destination candidate list 1000 registered in S604 is in the state shown in FIG. 10A.

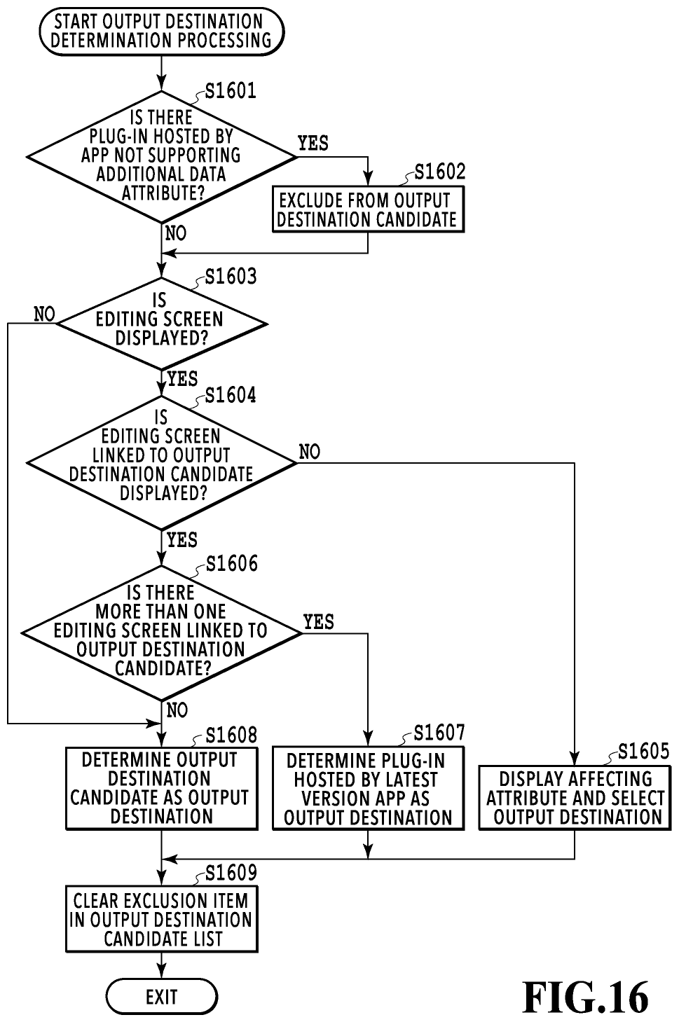

FIG. 16 is a flowchart showing a flow of output destination determination processing according to the second embodiment. S1601 and S1602 are the same as S1101 and S1102 in the output destination determination processing according to the first embodiment (FIG. 11), and thus description thereof will be omitted here.

By the processing in S1601 and S1602, plug-ins hosted by an app without functions that do not support the attributes are excluded from the output destination candidate list.

In S1603, the layout app 600 determines whether an editing screen is displayed. In this example, since there is no editing screen displayed yet, the layout app 600 proceeds to S1608 where the plug-in A, which is an output destination candidate, is determined as the output destination.

S1604, S1606, and S1607 are the same as S1103, S1105, and S1106 in FIG. 11, and thus description thereof will be omitted here. S1605 will be described later.

In S1609, the layout app 600 clears the output destination candidate list, as in S1107, and ends the plug-in determination processing. Thereafter, the layout app 600 executes the processing from S606 in FIG. 6, displays the editing screen 1201 shown in FIG. 12, and ends the label data addition processing.

### Adding Second Label Data 710

At this point, the layout app 600 displays the editing screen 1201 linked to the plug-in A as the output destination, and label data 700 is added as an editing target.

Next, it is assumed that the layout processing button 451 is operated in a state where label data 710 is created with the design app 400B of “version 2” as second additional data. The layout app 600 is requested to add label data by the plug-in B hosted by the design app 400B.

The layout app 600 executes second label data addition processing. The details of processing are the same as in the first embodiment, and thus description thereof will be omitted. The attribute information 802 of the additional data obtained in S601 is as shown in FIG. 8B. The function information 902 of the host app obtained in S603 is as shown in FIG. 9B. The output destination candidate list 1000 registered in S604 has the contents shown in FIG. 10B.

In S605 of the second label data addition processing, the layout app 600 executes the output destination determination processing shown in FIG. 16.

In the attribute information of the label data 710 as the second additional data, “BBB swatch color library” is not supported by the app hosting the plug-in A. The layout app 600 thus determines YES in S1601 and proceeds to S1602. In S1602, the plug-in A is excluded from the output destination candidate list 1000. FIG. 10C shows the output destination candidate list 1011 after execution of S1602.

In S1603, the layout app 600 determines whether an editing screen is displayed. Since the editing screen 1201 linked to the plug-in A is already displayed in the previous label data addition processing (S1603; YES), the processing proceeds to S1604.

In S1604, the layout app 600 determines whether an editing screen linked to the plug-in B, which is the output destination candidate, is displayed. As for the plug-in B (1002), “-” is registered in the item “window number” of the output destination candidate list 1000 in FIG. 10C, indicating that no editing screen is displayed (S1604; NO), and thus the processing proceeds to S1605.

In S1605, the layout app 600 identifies attributes that affect the output of edited data if the additional data 710 is added to the editing screen linked to the plug-in B for editing, and notifies the user to this effect. The layout app 600 also accepts the selection of the output destination by the user.

The processing of S1605 will be described. The layout app 600 first compares the attribute information 802 of the label data 710 as the additional data with the function information 901 of the host app of the plug-in A linked to the currently displayed editing screen, and specifies the contents of the attributes that affect the output of the edited additional data.

The host app “version 3” of the plug-in A linked to the editing screen does not support the BBB swatch color library. Therefore, the additional data (label data 710) created with “version 2” cannot be outputted with a desired result. Therefore, the “BBB swatch color library” is specified as the attribute that affects the output of the edited additional data, and a message is displayed to indicate that there is an affecting attribute in a case of outputting (saving) label data having this attribute.

Next, the layout app 600 obtains from the output destination candidate list the version information (version 3) of the host app of the plug-in A linked to the displayed window and the version information (version 2) of the host app of the plug-in B that is the output destination candidate. The layout app 600 displays a screen that allows the user to select between “version 3” and “version 2” of the host app. This screen also displays that “version 3” does not allow label data using the “BBB swatch color library” to be outputted with a desired result.

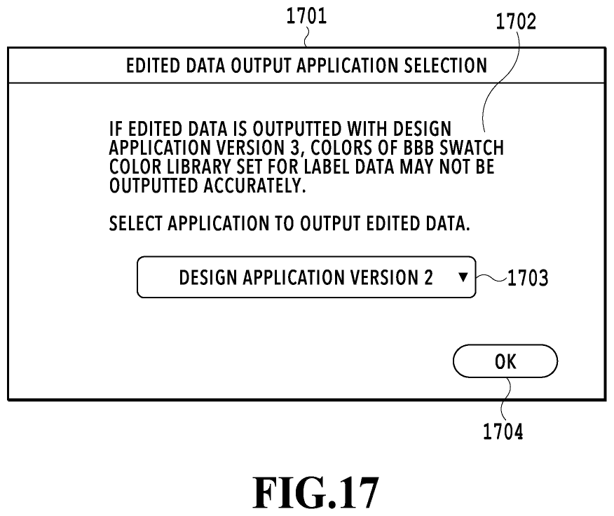

FIG. 17 is a diagram showing an example of a selection screen 1701 displayed in S1605. The selection screen 1701 displays a message 1702 about an attribute that affect the output of edited data, an output destination selection field 1703, a confirm button 1704, and the like. The message 1702 displays the contents of the attribute specified in S1605. The output destination selection field 1703 displays, as options, “version 3”, which is the host app of the plug-in A linked to the displayed editing screen, and “version 2”, which is the host app of the plug-in B as the output destination candidate.

As the confirm button 1704 is operated, the layout app 600 determines the host app of the version selected in the output destination selection field 1703 as the output destination. For example, in the example of FIG. 17, the design app 400 of “version 2” is selected, and thus the plug-in B is determined as the output destination.

In S1609, the layout app 600 clears the item “exclusion” in the output destination candidate list 1011, as in S1107, and ends the output destination determination processing shown in FIG. 16. Thereafter, the processing moves to S606 in FIG. 6. As in the first embodiment, the layout app 600 additionally displays the editing screen 1301 linked to the plug-in B shown in FIG. 13, and ends the label data addition processing shown in FIG. 6.

As described above, in the second embodiment, the layout app 600 obtains new label data while displaying the editing screen and, if determining that the new label data cannot be outputted with the host app linked to the displayed editing screen, specifies which attribute affects the output and notifies to this effect. The layout app 600 also displays the selection screen for accepting the selection of the output destination (design app). The selection screen also displays the contents of the attribute that affect the data output. This allows the user to select the app to be the output destination after understanding the contents of the attribute that affect the output of the edited data to the design app. This makes it possible to prevent output errors in the design app 400.

### Third Embodiment

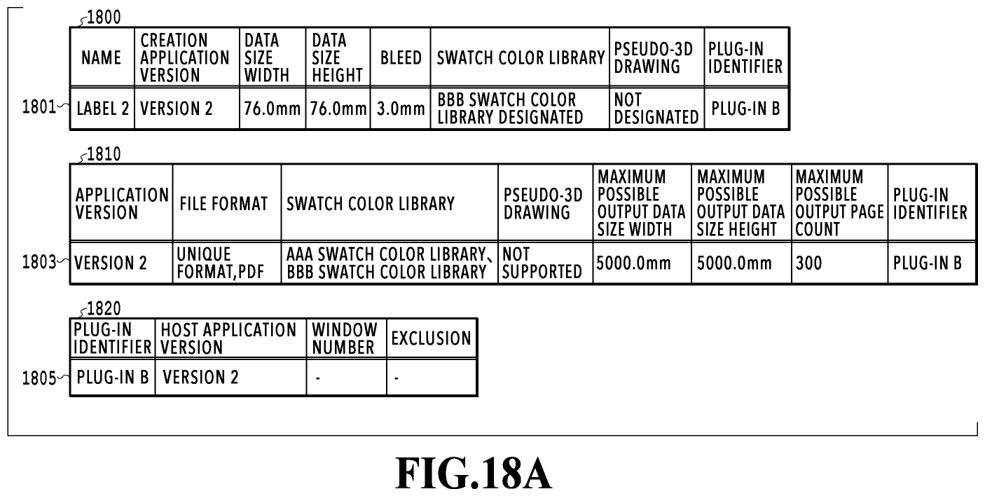

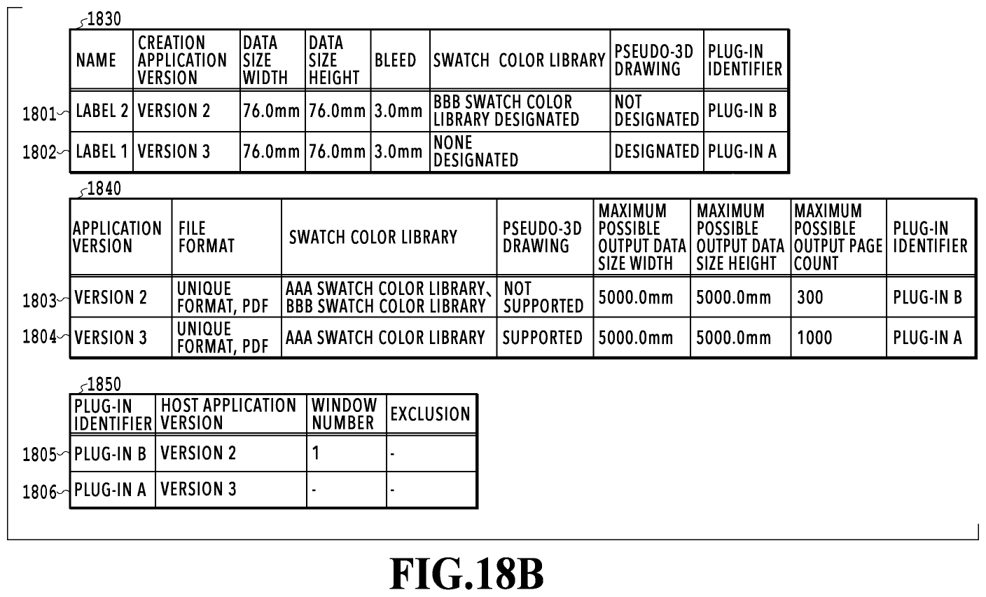

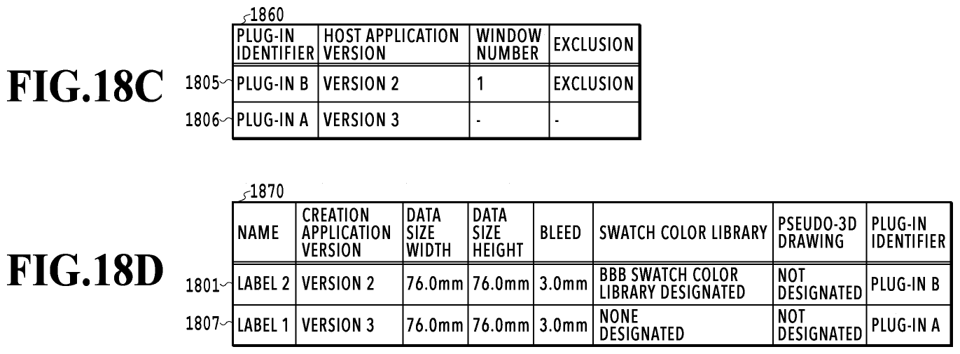

Next, a third embodiment of the present disclosure will be described with reference to FIGS. 18A to 20. Note that a basic configuration of the third embodiment is the same as those of the first and second embodiments. Therefore, a characteristic configuration of the third embodiment will be described below. In the third embodiment, again, two types of label data 700 and 710 shown in FIGS. 7A and 7B are created in advance with the design apps 400A and 400B, respectively. The attribute information 801 and 802 of the label data 700 and 710 are also the same as those in the first embodiment.

Here, the following case is assumed to describe the third embodiment.

To perform layout processing on the label data 710 created with the design app 400B of “version 2”, the layout app 600 is called via the plug-in B to open an editing screen (linked to the plug-in B).

Then, in order to add the label data 700 created with the design app 400A of version 3, the layout app 600 is called from the design app 400A of version 3 via the plug-in A.

The functions of the design app 400B, which is the host of the plug-in B linked to the displayed editing screen do not support the attributes of the second added label data 700. In this case, in the third embodiment, the layout app 600 inquires of the caller design app 400A (plug-in A) whether the format of the added label data 700 can be changed to a different format.

If the format change is possible, a request to change the format is made, attribute information is re-obtained for the label data after the format change, and the output destination determination processing is executed again. If the format change is not possible, the plug-in of the app of the latest version among the host apps that can support the attributes of the second label data 700 is determined as the output destination.

### Adding First Label Data 710

Label data 710 is created with the design app 400 of “version 2”, and the layout processing button 451 on the screen 401 is operated. The layout app 600 is requested to execute the label data addition processing by the plug-in B hosted by this design app 400B of “version 2”, and executes the label data addition processing shown in FIG. 6.

In the third embodiment, since all steps except for S605 are the same as those in the first or second embodiment, description thereof will be omitted.

FIG. 18A is a diagram showing attribute information 1800 obtained in S601, function information 1810 of the host app 400B obtained in S603, and an output destination candidate list 1820 registered in S604 in a case where the first label data 710 is added.

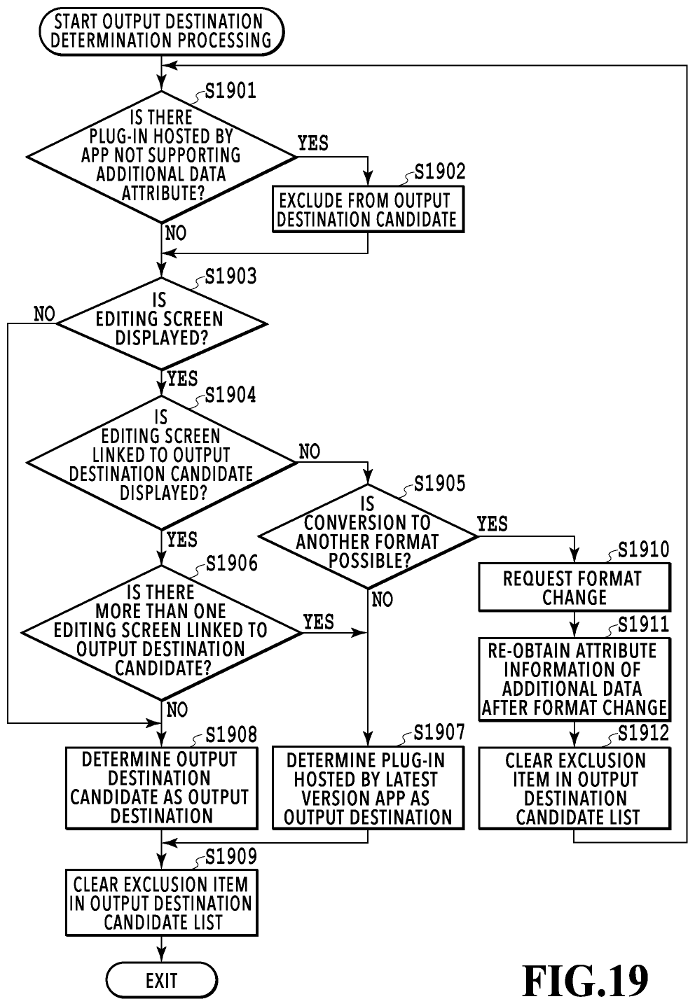

In the third embodiment, the layout app 600 executes processing shown in a flowchart of FIG. 19 in the output destination determination processing of S605. The output destination determination processing in the third embodiment will be described below with reference to FIGS. 19. S1901 to S1904 in FIG. 19 are the same as S1601 to S1604 in FIG. 16 (output destination determination processing of the second embodiment), and S1906 to S1909 are the same as S1606 to S1609, and thus description thereof will be omitted here. S1905, S1910, S1911, and S1912 that differ from the second embodiment will be described later. In a case of adding the first label data 710, the processing proceeds in the order of S1901; NO, S1903; NO, S1908, and S1909, and the plug-in B is determined as the output destination.

Next, in S1909, the layout app 600 clears the item “exclusion” in the output destination candidate list, as in S1107, and ends the output destination determination processing. The layout app 600 then proceeds to S606 in FIG. 6. In a case of adding the first label data, the processing proceeds in the order of S606; NO, S607, and S608. As shown in FIG. 13, the editing screen 1301 linked to the plug-in B is displayed, showing a state where the label data 710 is added as an editing target.

### Adding Second Label Data 700

Next, the label data 700 is created with the design app 400A of “version 3”, and the layout processing button 451 on the screen 401 is operated. The layout app 600 is requested via the plug-in A to perform label data addition processing.

In the label data addition processing, the layout app 600 executes the processing from S601, which is the same as in the first or second embodiment, and thus description thereof will be omitted.

FIG. 18B is a diagram showing attribute information 1830 obtained as the second label data 700 is added, function information 1840 of the host app 400A, and an output destination candidate list 1850.

The layout app 600 executes the output destination determination processing of S605. As described above, the output destination determination processing shown in the flowchart of FIG. 19 is executed.

Note that the processing of S1901 and S1902 are the same as in the first and second embodiments, and thus description thereof will be omitted. After execution of S1902, the contents of the output destination candidate list 1860 are as shown in FIG. 18C. That is, the plug-ins A and B are registered as output destination candidates, “1” is registered in the window number on the editing screen linked to the plug-in B, and the plug-in B is excluded.

In S1903, the layout app 600 determines whether the editing screen is displayed. As shown in the output destination candidate list 1860 in FIG. 18C, since the identifier “1” is registered in the window number of the plug-in B, the determination result in S1903 is YES and the processing proceeds to S1904.

In S1904, the layout app 600 determines whether the editing screen linked to the plug-in A, which is a candidate that is not excluded from the current output destination candidate list, is displayed. Since the window number of the plug-in A in the output destination candidate list 1860 is “-”, the determination result is NO and the processing proceeds to S1905.

In the third embodiment, the layout app 600 performs the following processing.

In S1905, the layout app 600 determines whether the additional data can be changed to a different format. The function information of the design app 400A of version 3 that has created the additional data (label data 700) is shown in function information 1804 in FIG. 18B. Referring to the item “file format” in the function information 1804, “unique format” and “PDF” are registered. Furthermore, the additional data has never been changed to PDF format (not changed).

Therefore, the layout app 600 determines that the additional data can be changed to a different format (S1905; YES) and proceeds to S1910. If the layout app 600 determines that the additional data cannot be changed to a different format (S1905; NO), on the other hand, the processing proceeds to S1907.

In S1910, the layout app 600 requests the caller plug-in A to change the additional data to a different format. In response to the request in S1910, in the subsequent processing, the label data 700 (version 3) obtained via the plug-in A is converted from the format unique to the design app to PDF.

In S1911, the layout app 600 re-obtains the attribute information of the additional data (label data 700P) after the format change. The layout app 600 obtains the attribute information of the label data 700P obtained in PDF format, and proceeds to S1912. FIG. 18D shows the re-obtained attribute information 1870 of the additional data.

In the attribute information 1870, the item “pseudo-3D drawing” of the attribute information 1807 of the label data 700P is “designated” in the case of the unique format of the design app (1802 in FIG. 18B). After the conversion to PDF, the target object is converted to pseudo 3D-drawn image data by the function of the design app 400A (version 3), and thus the status of the item is changed to “not designated”.

After re-obtaining the attribute information 1807 of the label data 700P with the format changed, the layout app 600 clears the item “exclusion” in the output destination candidate list in S1912, in order to re-determine the output destination, and returns to S1901. The output destination candidate list after S1912 returns to the output destination candidate list 1850 shown in FIG. 18B.

In S1901 after the format change and re-obtaining of attributes, the layout app 600 determines whether there is a plug-in hosted by an app that does not support the attributes of the additional data 700P. Here, the attribute information 1807 of the label data 700P as the additional data is compared with the function information 1803 and 1804 of the host app obtained thus far. It is determined here that there is no plug-in hosted by an app that does not support the attribute information 1807 of the label data 700P (S1901; NO), and the processing proceeds to S1903.

In S1903, the layout app 600 determines whether an editing screen is displayed. Since the editing screen of the plug-in B is displayed, the determination result in S1903 is YES, and the processing proceeds to S1904.

In S1904, the layout app 600 determines whether an editing screen linked to the output destination candidate registered in the output destination candidate list is displayed. That is, the layout app 600 checks if the plug-in linked to the currently displayed edit screen is excluded. In S1904 after re-obtaining the attributes, the window number of the output destination candidate plug-in B (1805) in the output destination candidate list 1850 is “1”, indicating that this plug-in B is not excluded (S1904; YES), and thus the processing proceeds to S1906.

In S1906, the layout app 600 determines whether there is more than one editing screen linked to the output destination candidate. That is, the layout app 600 determines whether a plurality of editing screens are displayed. In S1906 after re-obtaining the attributes of the second label data, there is only one editing screen displayed (S1906; NO), and thus the processing proceeds to S1908. In S1908, the layout app 600 determines the plug-in B as the output destination.

In S1909, the layout app 600 clears the item “exclusion” in the output destination candidate list, ends this flowchart, and moves to the processing from S606. Here, the layout app 600 proceeds to S608 after S606, adds the label data 700P with the format changed to the editing screen linked to the plug-in B as the output destination, and ends the label data addition processing.

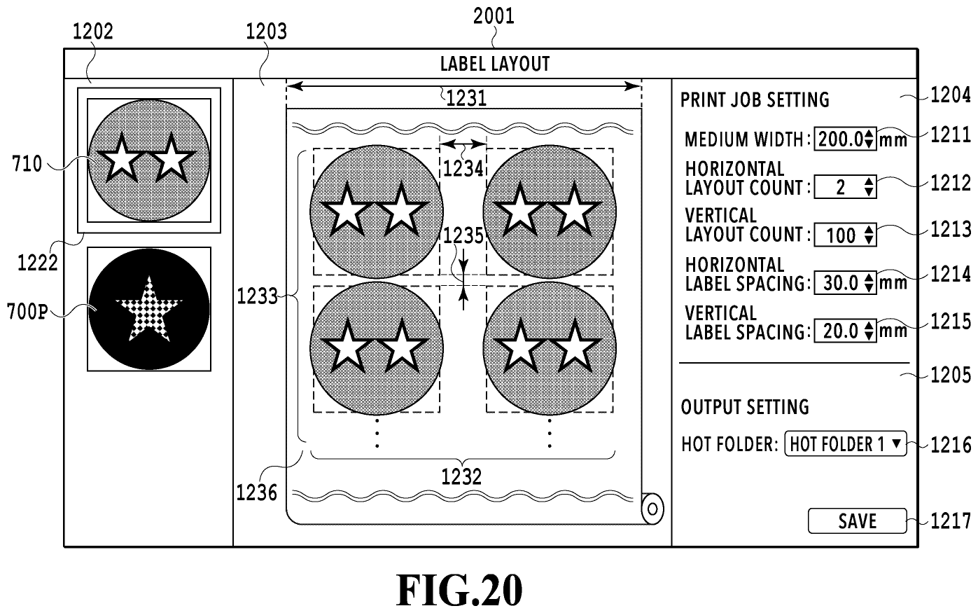

FIG. 20 shows an example of a screen (editing screen 2001) of the layout app 600 in a state where the label data 700P is added. The editing screen 2001 is a window linked to the plug-in B. The label data selection section 1202 displays the first added label data 710 and the label data 700P added this time with the format changed.

In this state, as the label data 700P is selected and dragged and dropped into the label layout area of the preview section 1203, data is created by combining the label data 710 and the label data 700P. Although the label data 710 and the label data 700P are created with different app versions, the pseudo-3D drawn object included in the label data 700P is converted to image data if it is in PDF format. This makes it possible to process the data with the design app 400B (version 2).

In a case of making a request to output (with the save button 1217) the data created by combining the label data 710 and 700P from the editing screen 2001, the attribute information included in the edited data can be supported by the design app 400B. Therefore, a desired result can be outputted.

As described above, if it is determined that the edited data includes attributes that cannot be supported by the functions of the host app 400 and the desired result cannot be outputted, the layout app 600 of the third embodiment changes the format of the additional data to a different format. The layout app 600 also re-obtains attribute information on the additional data with the format changed, and executes the output destination determination processing again. Changing the format makes it possible to output desired results in a case where a plurality of pieces of label data created with a plurality of applications are combined and edited with another application, and the edited data is outputted back to the caller app.

### Fourth Embodiment

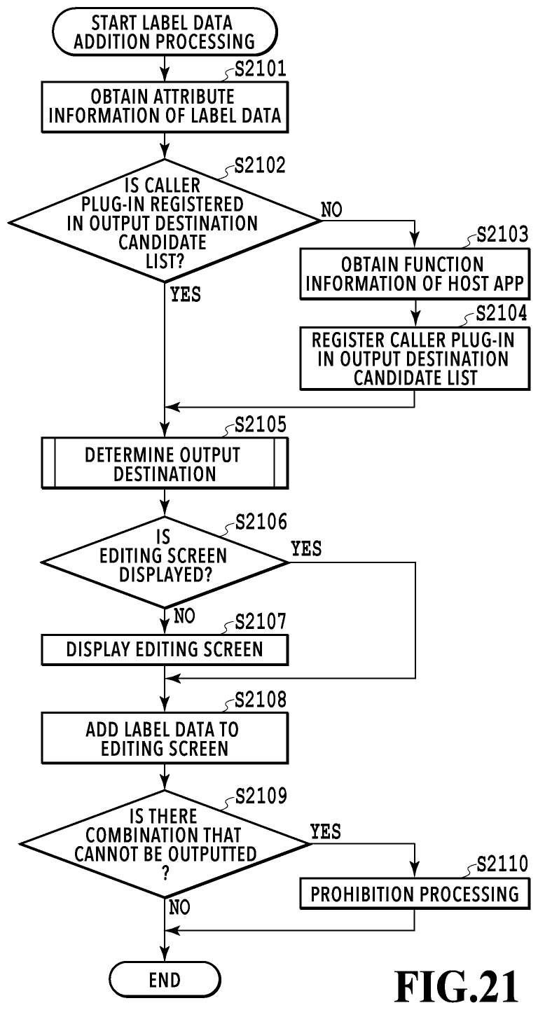

Next, a fourth embodiment of the present disclosure will be described with reference to FIGS. 21 to 27. Note that a basic configuration of the present embodiment is the same as that of the first embodiment, and thus a characteristic configuration of the present embodiment will be described below. The three types of label data 700, 710, and 720 used in the fourth embodiment are created with different versions of the design apps 400A, 400B, and 400C, respectively, as in the first embodiment. The attributes of these label data 700, 710, and 720 are the same as the attribute information 801, 802, and 803 (FIGS. 8A to 8C) described in the first embodiment.

In the fourth embodiment, in a case of adding label data, the layout app 600 determines whether the label data can be combined and outputted with label data already displayed on the editing screen. For label data that is prohibited from being combined, processing of prohibiting the operation is performed. In the fourth embodiment, unlike the first to third embodiments, the editing screen is not linked to any output destination plug-in. The plug-in that is the output destination of the edited data upon operation of the save button 1217 on the editing screen is the plug-in determined by the output destination determination processing.

As a specific example, description will be given below of a case where the layout app 600 is called to add the label data 700, 710, and 720 in this order.

FIG. 21 is a flowchart showing a flow of label data addition processing executed in the fourth embodiment. Note that S2101 to S2108 correspond to S601 to S608 in FIG. 6 (the first to third embodiments), respectively. However, the output destination candidate list generated in S2104, the output destination determination processing in S2105, and the editing screen in S2106 to S2108 are different from those in the first embodiment. Also, as shown in S2109 and S2110, prohibition processing is added. The differences from the first embodiment will be mainly described below.

### Adding First Label Data 700

First, the label data 700 is created with the design app 400A of “version 3”, and the layout processing button 451 on the screen 401 of the design app 400A is operated. The layout app 600 is requested by the plug-in A to execute the label data addition processing, and executes the label data addition processing shown in FIG. 21.

In the first label data addition processing, the layout app 600 performs the processing in the order of S2101, S2102; NO, S2103, and S2104. The obtained attribute information 801 of the additional data and the function information 901 of the host app 400A are the same as those shown in FIG. 8A and FIG. 9A.

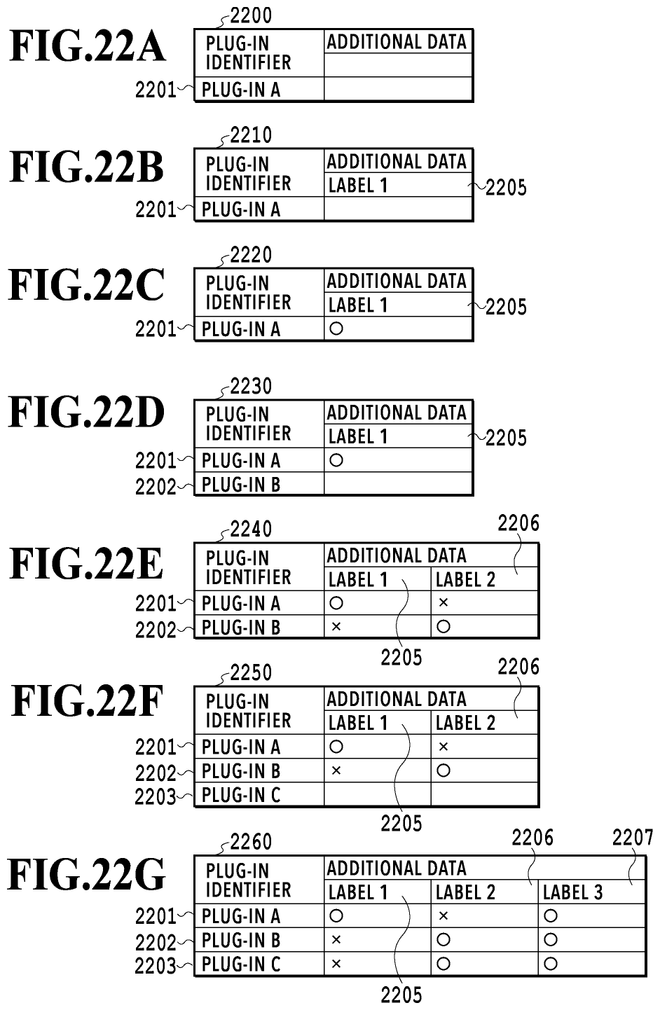

In S2104, the layout app 600 registers the caller plug-in A in the output destination candidate list shown in FIGS. 22A to 22G. The output destination candidate list used in the fourth embodiment will be described with reference to FIGS. 22A to 22G.

As shown in FIGS. 22A to 22G, combinations of the caller plug-in identifier and the identifier of the label data to be added (hereinafter referred to as the label identifier) are registered in output destination candidate lists 2200 to 2260 of the fourth embodiment. The layout app 600 registers a combination of the plug-in identifier and the label identifier in the output destination candidate list every time label data is added.

As the first label data 700 is added, “plug-in A” is registered in the plug-in identifier item 2201, as shown in the output destination candidate list 2200 in FIG. 22A. Then, the processing proceeds to S2105.

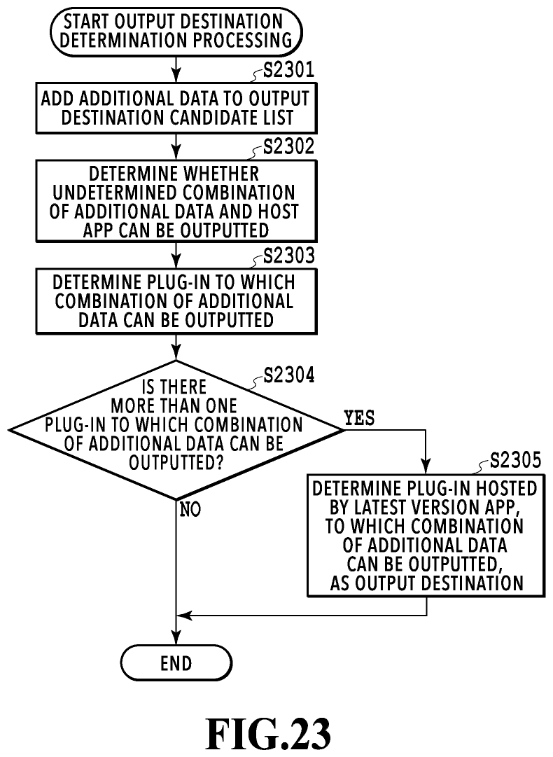

In S2105, the layout app 600 executes output destination determination processing shown in FIG. 23.

FIG. 23 is a flowchart showing a flow of the output destination determination processing executed in the fourth embodiment.

In S2301, the layout app 600 adds the identifier of the additional data to the output destination candidate list. By the processing of S2301, “label 1” as the identifier of the label data 700 is added to the additional data item 2205, as shown in the output destination candidate list 2210 in FIG. 22B.

In S2302, the layout app 600 determines whether the combination of the additional data and the host app can be outputted, for undetermined combinations. In this example, the layout app 600 makes the determination for the combination of label 1 and the host app 400A (version 3) of the plug-in A, which is yet to be determined in the output destination candidate list 2210. Upon making the determination, the layout app 600 refers to the attribute information 801 of the additional data and the function information 901 of the host app.

As a result of the determination, the attribute information 801 of label 1 can be supported by the design app 400A of “version 3”, and therefore it is determined that “output is possible”. The layout app 600 registers the information “o” representing that “output is possible” for the combination, as shown in FIG. 22C.

In S2303, the layout app 600 determines a plug-in to which a combination of additional data can be outputted, and proceeds to S2304. At this point, since this is the first additional data, there is no additional data to combine. Therefore, the plug-in to which the first additional data can be outputted is set as the plug-in to which additional data can be outputted in S2304.

In S2304, the layout app 600 determines whether there is more than one plug-in to which a combination of additional data can be outputted. At this point, there is no additional data to combine, and the determination result in S2304 is NO since there is only one plug-in to which additional data can be outputted (S2304; NO), and then this flowchart ends. If it is determined in S2304 that there is more than one plug-in (S2304; YES), the processing proceeds to S2305.

In S2305, the layout app 600 determines, as the output destination, the plug-in hosted by the app of the latest version, from among the plurality of plug-ins to which combinations of additional data can be outputted, and then ends this flowchart. The processing then proceeds to S2106 in FIG. 21.

In S2106, the layout app 600 determines whether an editing screen is displayed. Since there is no editing screen displayed yet as the first label data is added, the determination result is NO (S2106; NO) and the processing proceeds to S2107. If the editing screen is already displayed (S2106; YES), the processing proceeds to S2108.

In S2107, the layout app 600 displays the editing screen and proceeds to S2108.

In S2108, the layout app 600 adds the label data 700 (label 1), which is the additional data, to the editing screen as the data to be edited, and then ends this flowchart. As a result of the processing in S2108, the editing screen 1201 of the layout app 600 is displayed in a state where the label data 700 shown in FIG. 12 is added, as in the first embodiment. However, as described above, no plug-in is linked to the editing screen 1201 of the fourth embodiment. The plug-in that is the output destination of the edited data upon operation of the save button 1217 on the editing screen 1201 is the plug-in determined by the output destination determination processing of FIG. 23.

### Adding Second Label Data 710

Next, it is assumed that the label data 710 is created with the design app 400B of “version 2”, and the layout processing button 451 on the screen of the design app 400B is operated. The layout app 600 is requested by the plug-in B to execute the label data addition processing, and executes the label data addition processing (second time) shown in FIG. 21.

In the second label data addition processing, the layout app 600 proceeds with the processing in the order of S2101, S2102;NO, S2103, S2104, and S2105. The obtained attribute information 801 of the additional data and the function information 901 of the host application 400A are the same as those shown in FIGS. 8A and 9A. The contents of the output destination candidate list registered in S2104 are the contents of an output destination candidate list 2230 shown in FIG. 22D.

More specifically, “plug-in B”, the caller of the additional data, is additionally registered as the plug-in identifier in the output destination candidate list 2230 after the second execution in S2104.

In S2105, the layout app 600 executes the output destination determination processing (second time) of FIG. 23. In the second output destination determination processing, as in the first output destination determination processing, the processing proceeds in the order of S2301, S2302, S2303, and S2304, and this flowchart ends if the determination result in S2304 is NO. FIG. 22E shows an output destination candidate list 2240 after the second execution in S2302. The layout app 600 determines whether the combination of label 1 and plug-in B, the combination of label 2 and plug-in A, and the combination of label 2 and plug-in B, which are yet to be determined in the output destination candidate list 2210, can be outputted.

As a result of the determination in S2302, the combination of label 1 and plug-in A and the combination of label 2 and plug-in B can be outputted as shown in FIG. 22E.

It is determined in S2303 that there is no plug-in to which additional data can be outputted in combination (label 1 and label 2). Therefore, the output destination plug-in upon operation of the save button on the editing screen is the plug-in A to output (save) the label 1, and is the plug-in B to output (save) the label 2.

Next, the layout app 600 proceeds to S2106 in FIG. 21. The layout app 600 determines YES in S2106 since the editing screen is displayed as the first label data is added, and then proceeds to S2108. In other words, the layout app 600 proceeds to S2108 without opening a new editing screen.

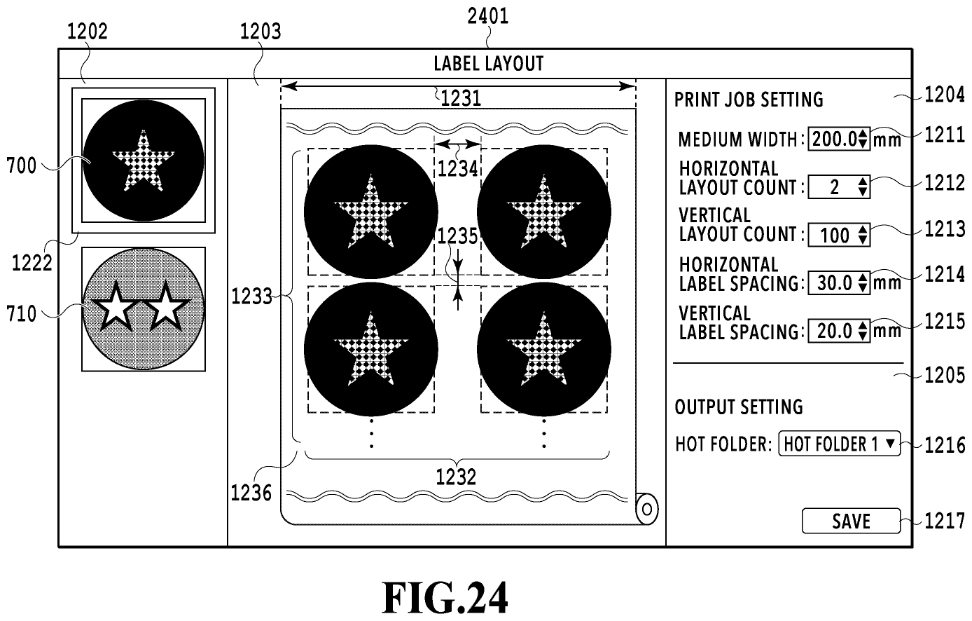

In S2108, the layout app 600 adds the label data 710, which is the additional data, to the currently displayed editing screen as data to be edited. FIG. 24 shows the contents displayed in the editing screen at this point.

As shown in FIG. 24, two pieces of label data 700 and 710 are added to the editing screen 2401 of the layout app 600 as the data to be edited.

In S2109, the layout app 600 determines whether there is a combination of label data that cannot be outputted, among the displayed label data. As a result of S2303 in FIG. 23, it is determined that the combination of label 1 and label 2 cannot be outputted. Therefore, the layout app 600 determines YES in S2109 and proceeds to S2110. In S2109, if there is no combination of additional data that cannot be outputted (S2109; NO), this flowchart ends.

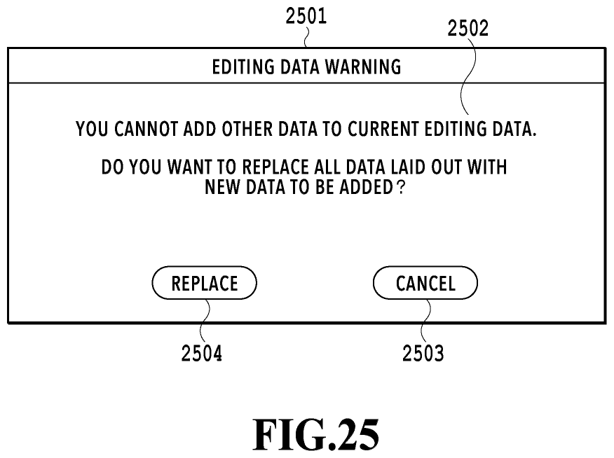

In S2110, the layout app 600 executes prohibition processing. In the prohibition processing, the layout app 600 prohibits the selection of the label data 710, which is the latest additional data, among the label data displayed on the currently displayed editing screen 2401, and the drag-and-drop operation to the label layout area of the preview section 1203. This prohibition processing may be processing of prohibiting any drag-and-drop operations by control on the screen, or may be processing of displaying a warning screen as shown in FIG. 25.

FIG. 25 shows an example of a warning screen 2501. The warning screen 2501 has a warning message display area 2502, a cancel button 2503, and a replace button 2504. The warning message display area 2502 displays a message indicating that label data is added, for which combination operation is prohibited, and a message inquiring whether to replace all the label data laid out with label data to be newly added.

As the cancel button 2503 is operated, the layout app 600 closes the warning screen 2501 and returns to the previous screen. As the replace button 2504 is operated, the layout app 600 closes the warning screen 2501 and replaces all the label data laid out with the selected label data.

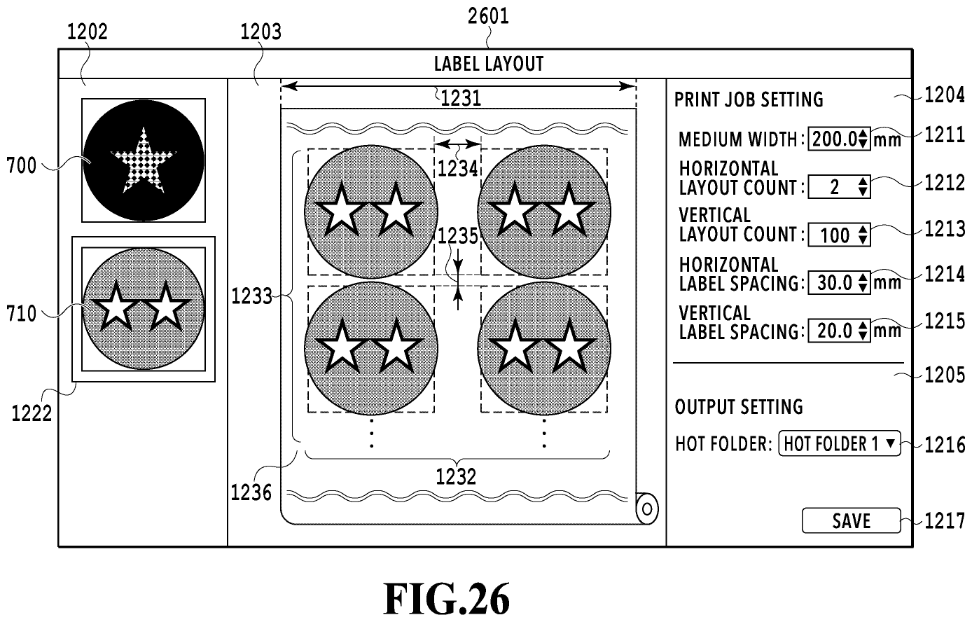

FIG. 26 is a diagram showing an example of a screen 2601 of the layout app 600 in a case where the replace button 2504 is operated on the warning screen 2501 displayed while the editing screen 2401 of FIG. 24 is displayed. As shown in FIG. 26, in the label layout area of the preview section 1203 of the editing screen 2601, the label data 700 already laid out is replaced with the newly added label data 710.

### Adding Third Label Data 720

Next, it is assumed that the label data 720 is created with the design app 400C of “version 1” and the layout processing button 451 on the screen of the design app 400C is operated. The layout app 600 is requested by the plug-in C to execute label data addition processing, and executes the label data addition processing (third time) of FIG. 21.

In the third label data addition processing, the layout app 600 proceeds the processing in the order of S2101, S2102; NO, S2103, S2104, and S2105. The obtained attribute information 801 of the additional data and the function information 901 of the host application 400A are the same as those shown in FIGS. 8A and 9A. The contents of the output destination candidate list registered in S2104 are the contents of an output destination candidate list 2250 shown in FIG. 22F.

More specifically, “plug-in C”, the caller of the additional data, is additionally registered as the plug-in identifier in the output destination candidate list 2250 after the third execution in S2104.

In S2105, the layout app 600 executes the output destination determination processing (third time) shown in FIG. 23. In the third output destination determination processing, the processing proceeds in the order of S2301, S2302, S2303, S2304 (YES), and S2305, and then the output destination determination processing ends.

In S2302 for the third time, the layout app 600 determines whether the combination of label 1 and plug-in C, the combination of label 2 and plug-in C, the combination of label 3 and plug-in A, the combination of label 3 and plug-in B, and the combination of label 3 and plug-in C, which are yet to be determined in the output destination candidate list 2210, can be outputted. FIG. 22G shows an output destination candidate list 2260 after the determination.

As shown in FIG. 22G, the combination of label 1 and plug-in A, the combination of label 2 and plug-in B, the combination of label 2 and plug-in C, the combination of label 3 and plug-in A, the combination of label 3 and plug-in B, and the combination of label 3 and plug-in C can be outputted.

In the determination of S2303, the layout app 600 determines that there is a plug-in to which additional data can be outputted in combination (label 1, label 2, and label 3). As a result, it is determined that there is no plug-in to which the combination of “label 1, label 2, and label 3” can be outputted, that the combination of “label 1 and label 3” can be outputted to the plug-in A, and that the combination of “label 2 and label 3” can be outputted to the plug-ins B and C.

The determination result in S2304 is YES since the combination of “label 2 and label 3” can be outputted to the two plug-ins B and C which can support the attribute information of both labels, and then the processing proceeds to S2305. In S2305, the plug-in C, which is the latest version, is determined as the output destination for the combination of “label 2 and label 3”. For the combination of “label 1 and label 3”, the plug-in A which can support the attribute information of both labels is determined as the output destination. The plug-in A is used to output the label 1 (only), the plug-in B is used to output the label 2 (only), and the plug-in A (latest version) is used to output the label 3 (only).

The layout app 600 then proceeds to S2106 in FIG. 21. The layout app 600 determines YES in S2106 since the editing screen is already displayed (S2106; YES), and proceeds to S2108.

In S2108, the layout app 600 adds label data 720 to be edited to the displayed editing screen (FIG. 24 or 26).

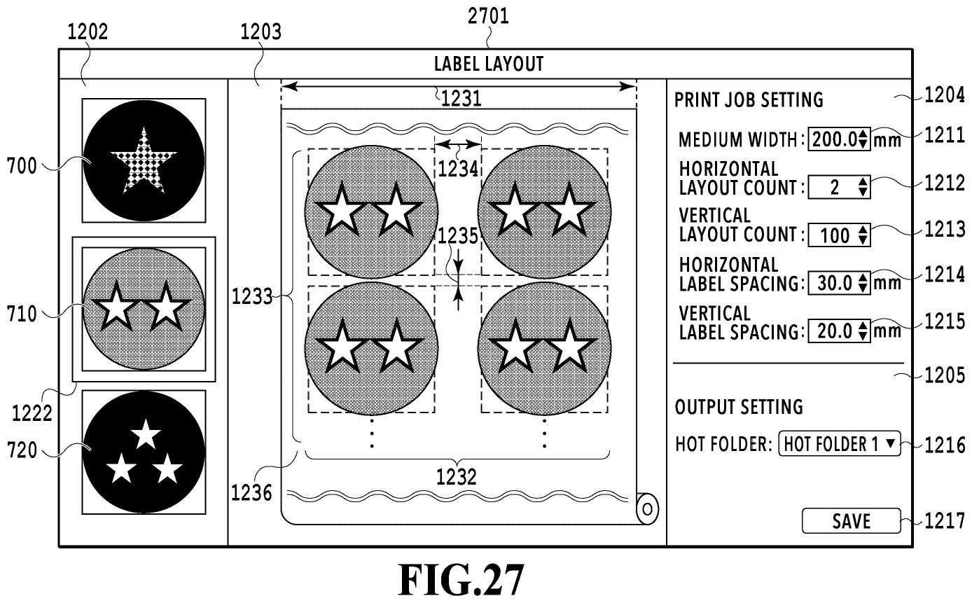

FIG. 27 is a diagram showing an example of an editing screen 2701 of the layout app 600 after the label data addition processing is executed in S2108 upon addition of the third label data 720.

In S2109, the layout app 600 determines whether there are any combinations of additional data that cannot be outputted. As a result of the output destination determination processing, the combination of label 1 and label 2, and the combination of label 1, label 2, and label 3 cannot be outputted (S2109; YES). Therefore, the layout app 600 proceeds to the prohibition processing of S2110 to prohibit operations on these combinations.

Note that the combination of label 1 and label 3 or the combination of label 2 and label 3 can be outputted, and thus the prohibition processing is not performed on these combinations in S2110.

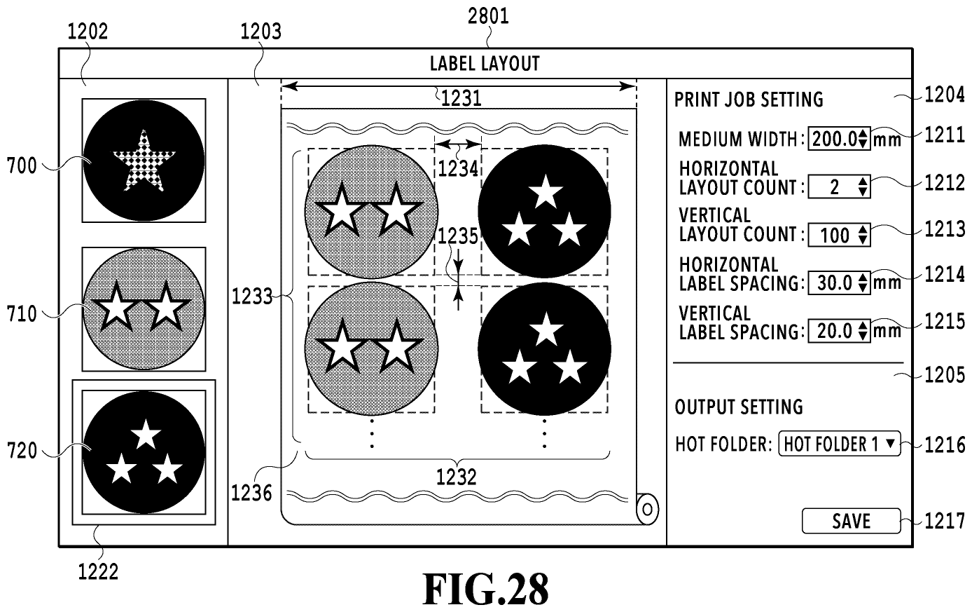

FIG. 28 shows an example of an editing screen 2801 in which the label data 720 of the label 3 is laid out in the label layout area by drag-and-drop. In the preview section 1203 of the editing screen 2801, a vertical column of labels 2 (label data 710) laid out in the state of FIG. 27 is replaced with the newly added label data 720, resulting in a combination of labels 2 and 3. If the save button 1217 is operated in this state, the edited data is outputted to the host app of the plug-in B, which is the output destination for the “combination of label 2 and label 3” determined in the output destination determination processing of FIG. 23.

As described above, in the fourth embodiment, the layout app 600 determines the output destination based on the combination of additional data without linking the editing screen to the plug-in. For additional data that cannot be outputted in combination with the displayed label data, the layout app 600 prohibits editing operations on the editing screen or notifies by displaying a warning screen.

Therefore, in a case where data created with a plurality of apps is combined and edited with another app, and the edited data is outputted back to the caller app, operations on the editing screen are prohibited if there is no host app to which the data can be outputted in combination. The edited data can be outputted accurately to the host app.

### Fifth Embodiment

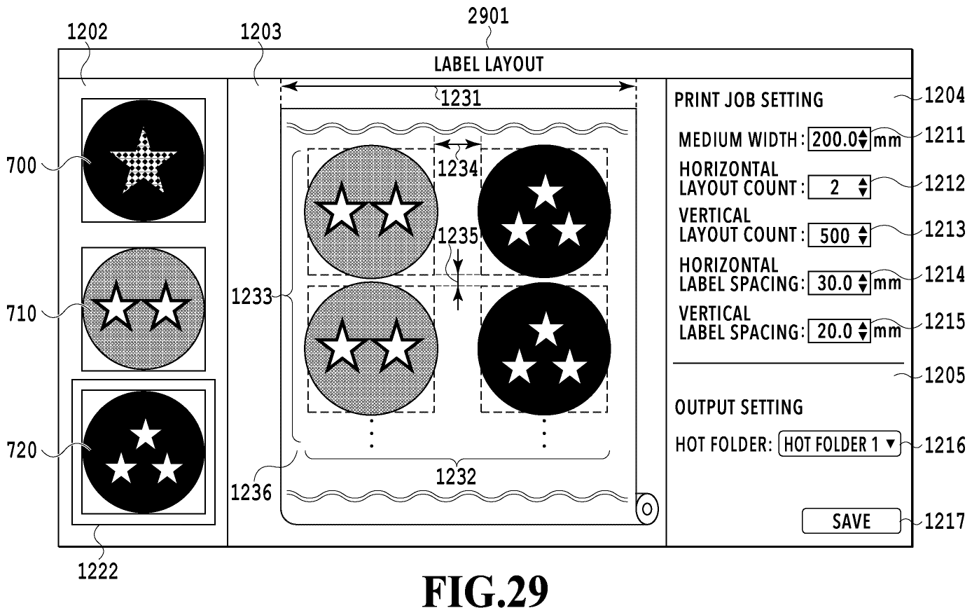

Next, a fifth embodiment of the present disclosure will be described with reference to FIGS. 29 to 33. In the fifth embodiment, description will be given of processing in a case where the save button 1217 is operated in a state where a plurality of pieces of label data are added to the editing screen, and editing operations are performed, such as layout operation and print job setting.

A basic configuration of the fifth embodiment is the same as that of the fourth embodiment, and thus a characteristic configuration of the fifth embodiment will be described below. The three types of label data 700, 710, and 720 used in the fifth embodiment are the label data 700, 710, and 720 added by the label data addition processing of the fourth embodiment. In the fifth embodiment, an editing screen that is not associated with any plug-in will be described as an example, as in the case of the editing screen of the fourth embodiment. However, the present embodiment is also applicable to the case of an editing screen associated with a plug-in, as described in the first to third embodiments.

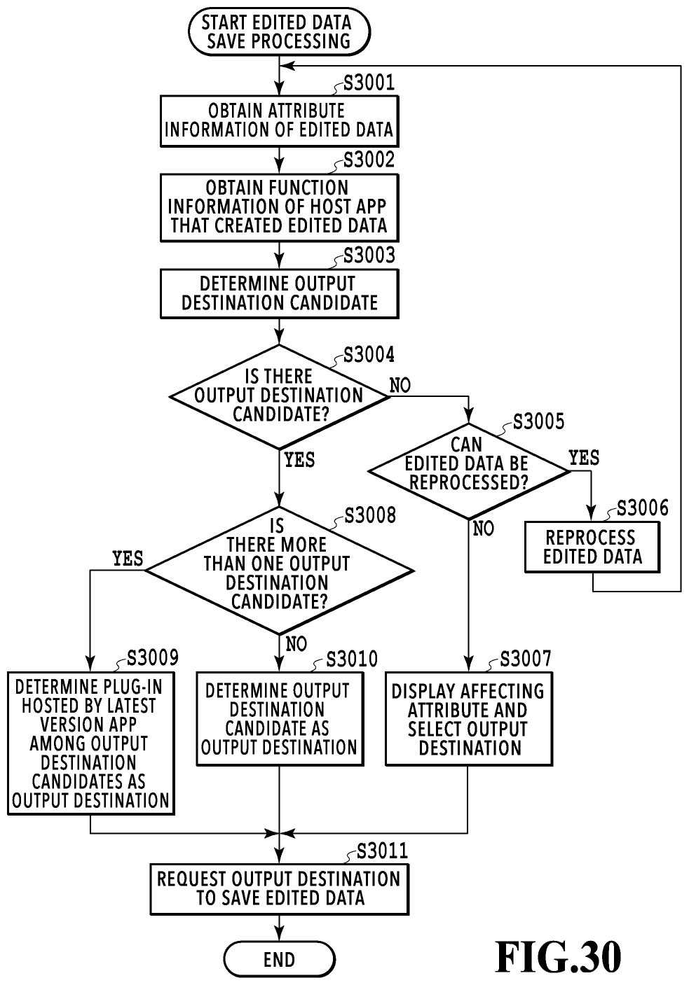

FIG. 29 is a diagram showing an editing screen 2901 in a state where label data 700, 710, and 720 are added, the label data 710 and the label data 720 are laid out in combination, and an editing operation such as print job setting is performed in the layout app 600. In the print job setting, the vertical layout count 1213 is set to “500”. As the save button 1217 is operated on the editing screen 2901, the layout app 600 starts edited data save processing shown in FIG. 30.

FIG. 30 is a flowchart showing a flow of the edited data save processing.

In S3001, the layout app 600 obtains attribute information of the edited data. The edited data is a combination of the label data 710 and the label data 720 (hereinafter referred to as combined data or edited data) as displayed in the preview section 1203 in FIG. 29. The attribute information of the edited data includes attribute information 802 and 803 of the label data 710 and 720 to be combined as the combined data, as well as information on print job settings (medium width, horizontal layout count, vertical layout count, horizontal label spacing, and vertical label spacing) and output settings (hot folder to save to).

As the attribute information of the combined data, the layout app 600 obtains the attribute information 802 and 803 of the label data 710 and label data 720, and the setting information on the print job settings and output settings described above. The attribute information 802 and 803 are obtained by the processing of S2101 upon addition of the label data, and stored in the RAM.

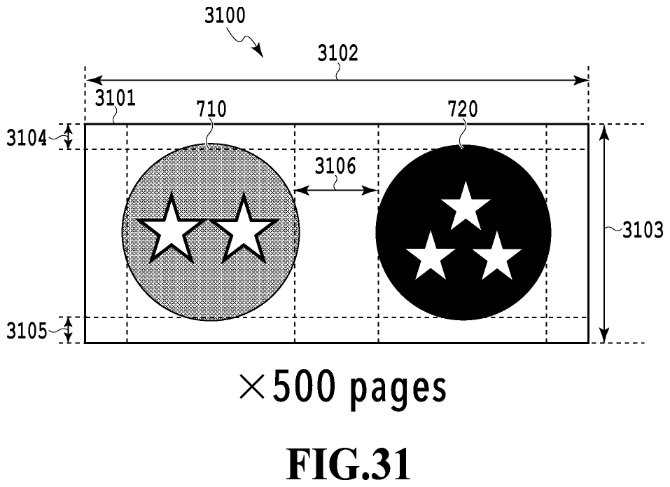

FIG. 31 is a diagram schematically showing edited data 3100. The edited data 3100 is data for 500 pages, each page containing data 3101. One page of data 3101 includes the label data 710 and the label data 720.

The one page of data 3101 has a width 3102 of 200.0 mm, which is set in the medium width 1211. The one page of data 3101 has a height 3103 of 90.0 mm, which is obtained by adding 20.0 mm (the sum of spacing 3104 and spacing 3105) set in the vertical label spacing 1215 to the label data finished size of 70.0 mm calculated by subtracting the sum 6.0 mm of top and bottom bleed widths from the data height of 76.0 mm of the label data 710 and label data 720. The label data 710 and label data 720 are laid out in the center of the page, maintaining a spacing 3106 of 30.0 mm set in the horizontal label spacing 1214.

Since the vertical layout count 1213 is set to “500”, the output page count of the edited data 3100 is set to “500”. That is, the design app 400 is requested to output 500 pages of the one page of data 3101.

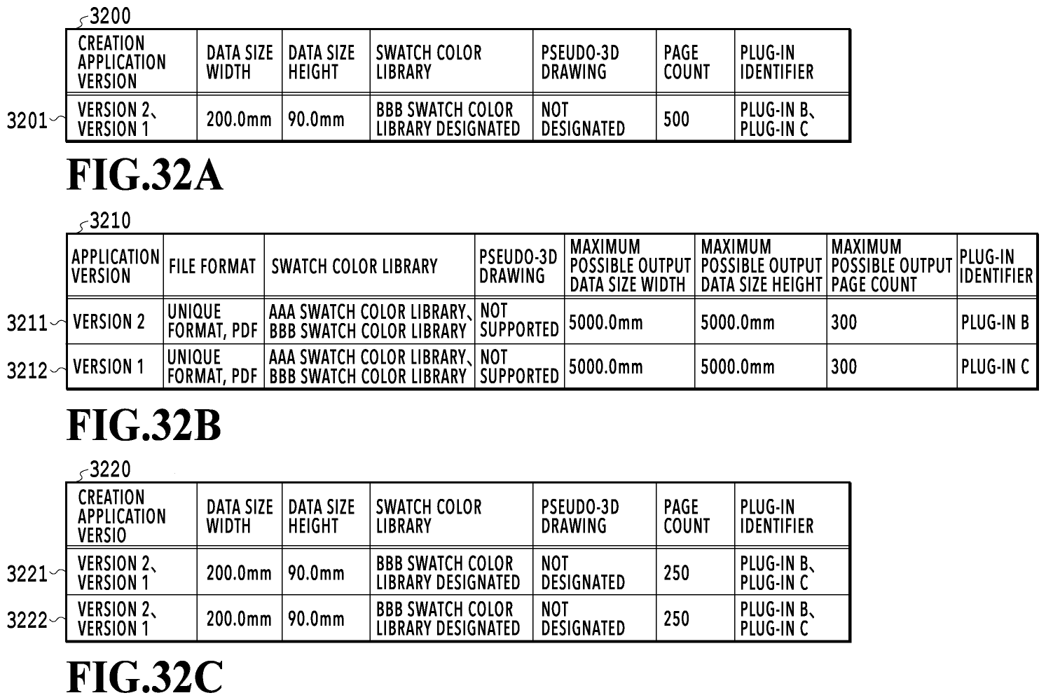

FIG. 32A shows attribute information 3200 obtained in S3001 of the edited data save processing. Here, the layout app 600 obtains attributes 3201 as attribute information of the edited data 3100.

In S3002, the layout app 600 obtains function information of the host app that created the edited data 3100. The host apps that created the label data 710 and 720 included in the edited data 3100 are the design app 400B of version 2 and the design app 400C of version 1. Therefore, the function information is obtained from the plug-in B and the plug-in C.

FIG. 32B shows function information 3210 obtained by the layout app 600 in S3002. Function information 3211 of the design app 400B of version 2 and function information 3212 of the design app 400C of version 1 are obtained.

In S3003, the layout app 600 determines an output destination candidate. The layout app 600 determines a plug-in hosted by an app that can support the attributes of the edited data 3100, as the output destination candidate. Specifically, the layout app 600 compares the attribute information 3200 obtained in S3001 with the function information 3210 obtained in S3002 to determine an output destination that can support the attributes of the edited data 3100.

In the example of FIGS. 32A and 32B, referring to the item “maximum possible output page count” in the function information 3211 and 3212, the maximum page count is “300” for both apps, and therefore the page count “500” set in the attribute information 3201 of the edited data cannot be supported. In S3003, therefore, it is determined that there is no output destination candidate.

In S3004, the layout app 600 determines whether it is determined in S3003 that there is an output destination candidate. In the above example, since it is determined that there is no output destination candidate, the layout app 600 determines NO and proceeds to S3005. If there is an output destination candidate (S3004; YES), the layout app 600 proceeds to S3008.

In S3005, the layout app 600 determines whether the edited data 3100 can be reprocessed. Here, reprocessing means processing data so that the final output result of the output data (edited data) can be maintained. For example, the edited data 3100 can be reprocessed by splitting the total page count data of “500” as the attribute information of the edited data 3100 into two pieces of data, each having a total page count of “250”. The layout app 600 determines that the edited data 3100 can be reprocessed (S3005; YES), and proceeds to S3006. If the edited data 3100 cannot be reprocessed (S3005; NO), the layout app 600 proceeds to S3007.

In S3007, the layout app 600 specifies and displays attributes that affect the output of the edited data, and accepts the selection of an output destination by the user from among the host apps that created the label data included in the edited data 3100. The processing of S3007 is the same as the processing of S1605 in the output destination determination processing (FIG. 16) of the second embodiment. That is, the layout app 600 displays a selection screen similar to the selection screen 1701 shown in FIG. 17, and accepts the selection of the host app to be the output destination.

In S3006, the layout app 600 reprocesses the edited data 3100, and then returns to S3001. Here, as described in the explanation of S3005, the layout app 600 reprocesses the edited data 3100 by splitting the total page count “500” into two pieces of data, each having the total page count “250”.

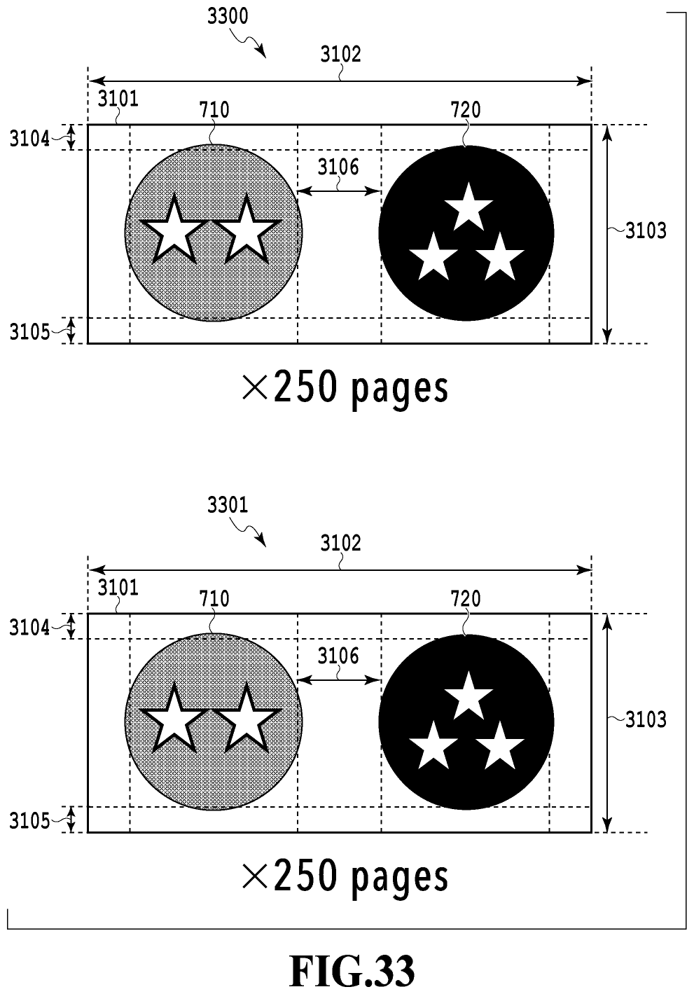

FIG. 33 is a diagram showing the edited data after the reprocessing. FIG. 33 shows that the data is split by the reprocessing into two pieces of edited data 3300 and 3301, each having the total page count set to “250”. Note that no changes are made to the original data 3101 other than the page count.

In S3001 after the reprocessing, the layout app 600 obtains attribute information of the reprocessed edited data 3300 and 3301. As in the attribute information 3220 shown in FIG. 32C, attribute information 3221 and 3222 are obtained for the edited data 3101 and 3102 with the total page count of “250”, respectively. Note that the attribute information 3221 and 3222 after the reprocessing are the same as the attribute information 3201 before the reprocessing shown in FIG. 32A, except for the page count.

In S3002 after the reprocessing, the layout app 600 obtains function information of the host app that created the reprocessed edited data 3300 and 3301. As in the previous case, function information 3211 and 3212 shown in FIG. 32B are obtained.

In S3003 after the reprocessing, the layout app 600 determines an output destination candidate for the reprocessed edited data 3300 and 3301. The layout app 600 compares the attribute information 3220 and the function information 3210 obtained in S3001 and S3002 after the reprocessing to determine an output destination that can support the attribute information 3220. From the contents of FIGS. 32B and 32C, the host apps of the plug-ins B and C can both output the reprocessed edited data. Therefore, the layout app 600 determines the plug-in B and the plug-in C as the output destination candidates.

In S3004 after the reprocessing, the layout app 600 determines whether there is any output destination candidate determined in S3003. Since there are two output destination candidates, the plug-in B and the plug-in C, here, the layout app 600 determines YES and proceeds to S3008. If there is no output destination candidate (S3004; NO), the layout app 600 proceeds to S3005.

In S3008, the layout app 600 determines whether there is more than one output destination candidate. In this example, there are two plug-ins, the plug-in B and the plug-in C, the layout app 600 determines YES and proceeds to S3009. If there is only one output destination candidate (S3008; NO), the layout app 600 proceeds to S3010.

In S3009, the layout app 600 determines the host app of the latest version as the output destination, among the plurality of output destination candidates determined in S3003, and proceeds to S3011. In this case, the host app of the plug-in B is “version 2” and the host app of the plug-in C is “version 1”, and thus the layout app 600 determines the plug-in B with the newer version as the output destination.

In S3010, the layout app 600 determines the output destination candidate determined in S3003 as the output destination and proceeds to S3011.

In S3011, the layout app 600 requests the plug-in determined as the output destination in S3007, S3009, or S3010 to save the edited data. In this example, the layout app 600 requests the plug-in B to output the label data defined by the reprocessed edited data 3300 and 3301 in PDF file format. The output destination is the hot folder 220 specified in the hot folder list selection 1216. This flowchart then ends.

As described above, in the fifth embodiment, a plurality of pieces of label data created with a plurality of apps are combined and edited with another app, and the edited data is outputted back to the caller app. In this event, the layout app 600 determines the output destination for the edited data based on the attribute information and the function information of the host app. If it is determined that a desired result cannot be outputted, the layout app 600 reprocesses the edited data if possible so that the final output result is maintained, and executes the output destination determination processing again for the reprocessed edited data.

The edited data is thus reprocessed so as to be supported by the design app 400. This makes it possible to output the reprocessed edited data back to the caller app with the desired result.

In the fifth embodiment, the description is given of the case where the save button is operated on the editing screen of the fourth embodiment. However, the processing of the fifth embodiment may be implemented in combination with the first to third embodiments. That is, as described in the first to third embodiments, even in a case where the output destination is determined upon addition of label data and the save button is operated on the editing screen linked to the output destination, the edited data save processing described in the fifth embodiment may be implemented and the output destination may be redetermined. This makes it possible to deal with a case where a page count that cannot be supported by the app linked to the editing screen is set in the print job setting on the editing screen in the first to third embodiments, for example.

Although the embodiments of the present disclosure have been described with reference to the accompanying drawings, the present disclosure is not limited to such examples. It is apparent that various changes or modifications can be conceived by those skilled in the art within the scope of the technical ideas of the present disclosure. These changes or modifications are understood to naturally fall within the technical scope of the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-140008, filed Aug. 30, 2023, and No. 2023-140025, filed Aug. 30, 2023, which are hereby incorporated by reference wherein in their entirety.

What is claimed is:

1. An information processing apparatus comprising:
a second application called via a plug-in module built into one or more first applications that are host applications, and configured to obtain data created by the first application via the plug-in module, process the obtained data as data to be processed, and return the processed data to the first application via one of the plug-in modules, wherein
the second application includes
an obtaining unit configured to obtain attribute information of the data to be processed as the data to be processed is obtained, and obtain function information of the first application that created the data to be processed, and
a determination unit configured to determine the first application to return the processed data based on the attribute information and the function information obtained by the obtaining unit, and determine the plug-in module hosted by the determined first application as an output destination of the processed data.

2. The information processing apparatus according to claim 1, wherein
the determination unit determines, as a candidate for the output destination, the plug-in module hosted by the first application whose function information includes a function that can support the attribute information obtained by the obtaining unit.

3. The information processing apparatus according to claim 2, wherein
the determination unit further includes
a registration unit configured to register the plug-in module that is a transmission source of the data to be processed as the candidate for the output destination, and
an exclusion unit configured to exclude from the candidates the plug-in module hosted by the first application that does not have a function supporting an attribute of the data to be processed, among the plug-in modules registered as the candidates by the registration unit.

4. The information processing apparatus according to claim 2, wherein
the attribute information and the function information include version information of the host application, and
the determination unit determines the candidate for the output destination based on the version information included in the attribute information and the version information included in the function information.

5. The information processing apparatus according to claim 2, wherein
if there is more than one candidate for the output destination,
the determination unit determines, as the output destination, the plug-in module hosted by the first application of a latest version among the candidates.

6. The information processing apparatus according to claim 3, further comprising:
a display control unit configured to display an operation screen of the second application in association with the output destination determined by the determination unit, and display the data to be processed on the operation screen.

7. The information processing apparatus according to claim 6, wherein
if the attribute information of second data to be processed, which is obtained in a state where the data to be processed is displayed on the operation screen and is different from the data to be processed, includes an attribute that cannot be supported by the first application that is the host of the output destination associated with the displayed operation screen,
the display control unit further displays a second operation screen different from the operation screen in association with the plug-in module that is the transmission source of the second data to be processed, and displays the second data to be processed on the second operation screen.

8. The information processing apparatus according to claim 6, wherein
if the attribute information of second data to be processed, which is obtained in a state where the data to be processed is displayed on the operation screen and is different from the data to be processed, includes an attribute that cannot be supported by the first application that is the host of the output destination associated with the displayed operation screen,
the determination unit further includes
an acceptance unit configured to accept a selection of the first application to return the processed data to.

9. The information processing apparatus according to claim 8, further comprising:
a notification unit configured to identify and notify an attribute that cannot be supported by the first application that is the host of the output destination associated with the displayed operation screen.

10. The information processing apparatus according to claim 6, further comprising:
if the attribute information of second data to be processed, which is obtained in a state where the data to be processed is displayed on the operation screen and is different from the data to be processed, includes an attribute that cannot be supported by the first application that is the host of the output destination associated with the displayed operation screen,
a format change unit configured to change a format of the second data to be processed; and
a re-obtaining unit configured to re-obtain the attribute information of the second data to be processed after the format is changed by the obtaining unit, wherein
the determination unit determines the output destination of the processed data including the second data to be processed after the format is changed, based on the attribute information and the function information re-obtained by the re-obtaining unit.

11. The information processing apparatus according to claim 2, wherein
the determination unit includes
a second registration unit configured to register, as the candidate for the output destination, the plug-in module that is determined, based on the attribute information and the function information, to be the destination to which a combination of a plurality of pieces of data to be processed can be outputted.

12. The information processing apparatus according to claim 11, further comprising:
a second display control unit configured to display an operation screen of the second application without associating the operation screen with the output destination.

13. The information processing apparatus according to claim 11, wherein
if there is more than one candidate for the output destination,
the determination unit determines, as the output destination, the plug-in module hosted by the first application of the latest version among the candidates.

14. The information processing apparatus according to claim 12, wherein
if there is no first application capable of outputting second data to be processed, which is obtained in a state where the data to be processed is displayed on the operation screen and is different from the data to be processed, in combination with the data to be processed that is displayed on the operation screen,
the second display control unit additionally displays the second data to be processed on the displayed operation screen,
the information processing apparatus further comprising
a prohibition unit configured to prohibit the second data to be processed from being operated on the operation screen.

15. The information processing apparatus according to claim 1, further comprising:
in a case of returning the processed data to the first application,
a redetermination unit configured to re-obtain, by the obtaining unit, the attribute information of the processed data and the function information of the first application that created the data to be processed included in the processed data, and redetermine the first application to return the processed data based on the re-obtained attribute information and function information.

16. The information processing apparatus according to claim 15, further comprising:
a reprocessing unit configured to reprocess the processed data so as to maintain a final output result if the redetermination unit cannot determine the first application to return the processed data to, wherein
the redetermination unit determines the first application to which data reprocessed by the reprocessing unit is to be returned.

17. The information processing apparatus according to claim 1, wherein
processing in the second application includes
at least one of layout of the data to be processed, print job setting, and save destination setting, and
the processed data includes at least one of information on the layout, information on the print job setting, and information on the save destination setting.

18. An information processing apparatus comprising:
a second application called via a plug-in module built into one or more first applications that are host applications, and configured to obtain data created by the first application via the plug-in module, process the obtained data as data to be processed, and return the processed data to the first application via one of the plug-in modules, wherein
the second application includes
an obtaining unit configured to obtain attribute information of the processed data in a case of returning the processed data to the first application, and obtain function information of the first application that created the data to be processed included in the processed data, and
a determination unit configured to determine the first application to return the processed data based on the attribute information and the function information obtained by the obtaining unit, and determine the plug-in module hosted by the determined first application as an output destination of the processed data.

19. The information processing apparatus according to claim 18, wherein
the determination unit determines, as a candidate for the output destination, the plug-in module hosted by the first application whose function information includes a function that can support the attribute information obtained by the obtaining unit.

20. The information processing apparatus according to claim 19, wherein
the attribute information and the function information include version information of the host application, and
the determination unit determines the candidate for the output destination based on the version information included in the attribute information and the version information included in the function information.

21. The information processing apparatus according to claim 19, wherein
if there is more than one candidate for the output destination,
the determination unit determines, as the output destination, the plug-in module hosted by the first application of the latest version among the candidates.

22. The information processing apparatus according to claim 19, wherein
if there is no candidate for the output destination,
the determination unit further includes
a reprocessing unit configured to reprocess the processed data so as to maintain a final output result, and
a re-obtaining unit configured to re-obtain the attribute information of data reprocessed by the reprocessing unit, and
the determination unit determines the first application to return the reprocessed data based on the attribute information re-obtained by the re-obtaining unit and the function information obtained by the obtaining unit.

23. The information processing apparatus according to claim 19, wherein
if there is no candidate for the output destination,
the determination unit further includes
an acceptance unit configured to accept a selection of the first application to return the processed data to, and
the determination unit determines the plug-in module hosted by the first application accepted by the acceptance unit as the output destination of the processed data.

24. The information processing apparatus according to claim 23, further comprising:
a notification unit configured to identify and notify an attribute that cannot be supported by a function included in the function information, from among the attribute information of the processed data obtained by the obtaining unit.

25. The information processing apparatus according to claim 18, further comprising:
a display control unit configured to display an operation screen of the second application and additionally display the data to be processed on the operation screen every time the data to be processed is obtained.

26. The information processing apparatus according to claim 25, further comprising:
if there is no first application capable of outputting second data to be processed, which is obtained in a state where the data to be processed is displayed on the operation screen and is different from the data to be processed, in combination with the data to be processed that is displayed on the operation screen,
a prohibition unit configured to prohibit the second data to be processed from being operated on the operation screen.

27. The information processing apparatus according to claim 18, wherein
processing in the second application includes
at least one of layout of the data to be processed, print job setting, and save destination setting, and
the processed data includes at least one of information on the layout, information on the print job setting, and information on the save destination setting.

28. An information processing method called via a plug-in module built into one or more first applications that are host applications, for obtaining data created by the first application via the plug-in module, processing the obtained data as data to be processed, and returning the processed data to the first application via one of the plug-in modules, comprising the steps of:
obtaining attribute information of the data to be processed as the data to be processed is obtained, and obtaining function information of the first application that created the data to be processed; and
determining the first application to return the processed data based on the attribute information and the function information as the data to be processed is obtained, and determining the plug-in module hosted by the determined first application as an output destination of the processed data.

29. An information processing method called via a plug-in module built into one or more first applications that are host applications, for obtaining data created by the first application via the plug-in module, processing the obtained data as data to be processed, and returning the processed data to the first application via one of the plug-in modules, comprising the steps of:
obtaining attribute information of the processed data in a case of returning the processed data to the first application, and obtaining function information of the first application that created the data to be processed included in the processed data; and
determining the first application to return the processed data based on the attribute information and the function information, and determining the plug-in module hosted by the determined first application as an output destination of the processed data.

30. A non-transitory computer readable storage medium storing a program which causes a computer to execute an information processing method called via a plug-in module built into one or more first applications that are host applications, for obtaining data created by the first application via the plug-in module, processing the obtained data as data to be processed, and returning the processed data to the first application via one of the plug-in modules, wherein
the information processing method includes the steps of
obtaining attribute information of the data to be processed as the data to be processed is obtained, and obtaining function information of the first application that created the data to be processed, and
determining the first application to return the processed data based on the attribute information and the function information as the data to be processed is obtained, and determining the plug-in module hosted by the determined first application as an output destination of the processed data.

31. A non-transitory computer readable storage medium storing a program which causes a computer to execute an information processing method called via a plug-in module built into one or more first applications that are host applications, for obtaining data created by the first application via the plug-in module, processing the obtained data as data to be processed, and returning the processed data to the first application via one of the plug-in modules, wherein
the information processing method includes the steps of
obtaining attribute information of the processed data in a case of returning the processed data to the first application, and obtaining function information of the first application that created the data to be processed included in the processed data, and
determining the first application to return the processed data based on the attribute information and the function information, and determining the plug-in module hosted by the determined first application as an output destination of the processed data.
